(19) United States
(12) Patent Application Publication
(10) Pub. No.: US 2014/0286593 A1
(43) Pub. Date: Sep. 25, 2014

(54) IMAGE PROCESSING DEVICE, IMAGE PROCESISNG METHOD, PROGRAM, AND IMAGING DEVICE

(71) Applicant: SONY CORPORATION, MINATO-KU (JP)

(72) Inventor: Satoshi NUMATA, Tokyo (JP)

(73) Assignee: SONY CORPORATION, MINATO-KU (JP)

(21) Appl. No.: 14/199,223

(22) Filed: Mar. 6, 2014

(30) Foreign Application Priority Data
Mar. 25, 2013 (JP) 2013-062088

(51) Int. Cl. G06T 5/00; G06T 11/60; G06T 7/20

(52) U.S. Cl. CPC G06T 5/002; G06T 7/20; G06T 11/60
USPC 382/275

(57) ABSTRACT

There is provided an image processing device including an image acquisition unit configured to acquire a first image obtained using a motion vector indicating motion between frames and a second image used as a reference image to obtain the motion vector; and an image generator configured to generate a third image by blending the first image with the second image by a predetermined blending ratio.

### CROSS REFERENCE TO RELATED APPLICATIONS

This application claims the benefit of Japanese Priority Patent Application JP 2013-062088 filed Mar. 25, 2013, the entire contents of which are incorporated herein by reference.

### BACKGROUND

The present disclosure relates to an image processing device, an image processing method, a program, and an imaging device.

In shooting (photographing) an image, a technology for obtaining an image with reduced noise by superimposing a plurality of continuously shot images (frames) is known. As an example, the plurality of images are superimposed on an image to be processed (hereinafter referred appropriately to as target image), and these plurality of images are shot continuously before or after shooting of the target image and are aligned by motion estimation and motion compensation are superimposed. In this case, images that are substantially the same as each other are integrated in the time direction, and thus the noise randomly included in each image is cancelled out, thereby reducing the noise. Hereinafter, the noise reduction (NR) achieved by such a method is referred to as frame NR process.

For a target block that is set in a target image, a local motion vector is estimated, and global motion that represents transformation over the entire image between two images is calculated by using the estimated local motion vector. The global motion typically represents the motion and the amount of motion of a background as a still image part of an image.

As a technique using the global motion, there is a technique disclosed in JP 2009-290827A. In the technique disclosed in JP 2009-290827A, an image is separated into a still background image part and a moving subject part, a motion-compensated image (referred appropriately as to MC image) is generated using a local motion vector which matches a global motion vector generated from global motion, and the MC image and a target image are superimposed. In this technique, by using adaptively the global motion vector and the local motion vector, the MC image is generated and the superimposition process is performed.

### SUMMARY

As an example, in the case where image shooting is performed in a dark place with low illuminance, it is very difficult to perform accurate motion estimation, and thus the reliability of a motion vector decreases. If an MC image based on a motion vector with low reliability is superimposed on a target image, there has been an issue that the quality of image obtained by the process is deteriorated.

Therefore, an embodiment of the present disclosure provides an image processing device, image processing method, program, and imaging device, capable of generating an appropriate image to be superimposed on a target image.

According to the present disclosure in order to achieve the above-mentioned object, there is provided an image processing device including an image acquisition unit configured to acquire a first image obtained using a motion vector indicating motion between frames and a second image used as a reference image to obtain the motion vector, and an image generator configured to generate a third image by blending the first image with the second image by a predetermined blending ratio.

According to the present disclosure, there is provided, for example, an image processing method in an image processing device, the image processing method including acquiring a first image obtained using a motion vector indicating motion between frames and a second image used as a reference image to obtain the motion vector, and generating a third image by blending the first image with the second image by a predetermined blending ratio.

According to the present disclosure, there is provided, for example, a program for causing a computer to execute an image processing method in an image processing device, the image processing method including acquiring a first image obtained using a motion vector indicating motion between frames and a second image used as a reference image to obtain the motion vector, and generating a third image by blending the first image with the second image by a predetermined blending ratio.

According to the present disclosure, there is provided, for example, an imaging device including an imaging unit, an image acquisition unit configured to acquire a first image obtained using a motion vector indicating motion between frames and a second image used as a reference image to obtain the motion vector, the second image being obtained through the imaging unit, an image generator configured to generate a third image by blending the first image with the second image by a predetermined blending ratio, and an image adder configured to add the third image and a target image.

According to one or more of embodiments of the present disclosure, it is possible to generate an appropriate image to be superimposed on a target image.

### BRIEF DESCRIPTION OF THE DRAWINGS

FIG. 1 is a conceptual view of an example of a frame NR process;

FIG. 2 is a diagram for explaining an example of the frame NR process at the time of shooting a still image;

FIG. 3 is a diagram for explaining an example of the frame NR process at the time of shooting a moving image;

FIG. 4 is a diagram for explaining an example of a typical frame NR process;

FIG. 5 is a diagram for explaining an example of the frame NR process according to an embodiment;

FIG. 6 is a flowchart illustrating the flow of the main process according to an embodiment;

FIG. 7 is a diagram illustrating an example of a local motion vector;

FIG. 8 is a diagram for explaining an example of a method of evaluating the reliability of a motion vector;

FIG. 9 is a diagram illustrating an example of a global motion vector;

FIG. 10 is a diagram illustrating an example of a local motion vector obtained for each block of a frame;

FIG. 11 is a diagram illustrating an example of applying a local motion vector or a global motion vector to each block of a frame;

FIG. 12 is a diagram for explaining an example of a method of evaluating the degree of background matching of a target block;

FIG. 13 is a flowchart illustrating an example of the process flow performed for obtaining a motion-compensated image;

FIG. 14 is a diagram for explaining an example of a method of efficiently performing a block matching process;

FIG. 15A is a diagram illustrating an example of change in the level of an input image in accordance with illuminance;

FIG. 15B is a diagram illustrating an example of setting gain in accordance with illuminance;

FIG. 15C is a diagram illustrating an example of the level of an input image whose gain is adjusted;

FIG. 16A is a diagram illustrating an example of the level of an input image whose gain is adjusted;

FIG. 16B is a diagram illustrating an example of setting a blending ratio in accordance with illuminance;

FIG. 17 is a block diagram illustrating an exemplary configuration of an imaging device;

FIG. 18 is a block diagram illustrating an exemplary configuration of a gain adjustor;

FIG. 19 is a block diagram illustrating an exemplary configuration of a motion vector estimating section;

FIG. 20 is a block diagram illustrating an exemplary configuration of a target block buffer;

FIG. 21 is a block diagram illustrating an exemplary configuration of a reference block buffer;

FIG. 22 is a block diagram illustrating an exemplary configuration of an image-to-be-added generation section; and

FIG. 23 is a block diagram illustrating an exemplary configuration of an image adder.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

<1. Embodiments>

<2. Modifications>

The embodiments and modifications to be described below are preferred illustrative examples of the present disclosure, and the disclosure is not intended to be limited to these embodiments and modifications.

### 1. Embodiments

(Overview of Embodiments)

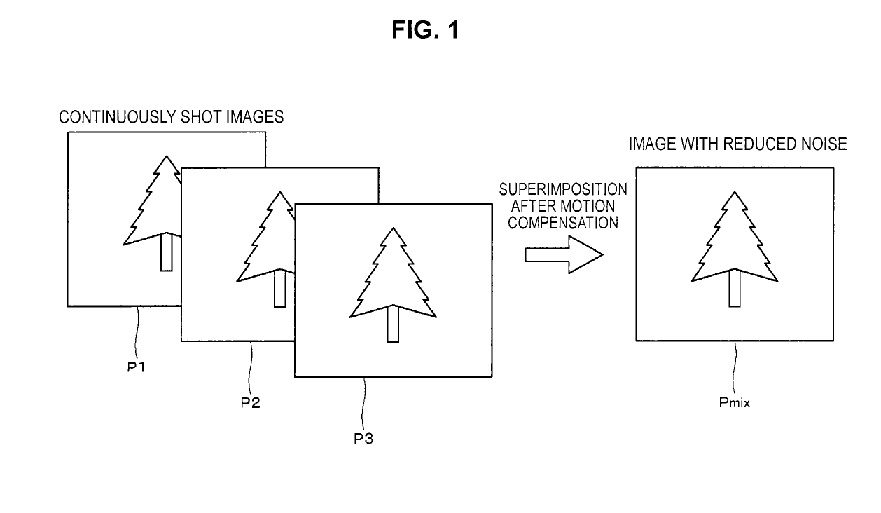

Prior to describing an overview of an embodiment of the present disclosure, a typical frame noise reduction (NR) process will be described below. FIG. 1 is a conceptual view of a typical frame NR process. In the frame NR process, a plurality of images P1 to P3 continuously shot are aligned in position (motion-compensated) and then superimposed on each other, resulting in providing an image Pmix with reduced noise. The noise is reduced when a plurality of continuously shot images are superimposed because images which are substantially the same as each other are integrated in the time direction and thus the noise randomly included in each image is cancelled out.

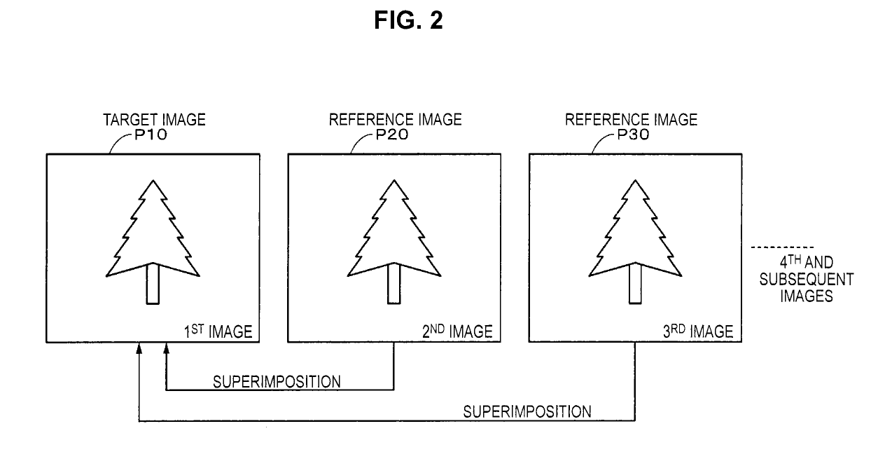

The number of a plurality of images P1 to P3 to be superimposed is not limited to three, but two images or four or more images may be used. As an example, when an imaging device captures a still image, as shown in FIG. 2, a first captured image P10 from among a plurality of images that are continuously captured at a high speed becomes a target image. The second and subsequent captured images (for example, images P20 and P30) serve as reference images and are sequentially superimposed on the target image P10. A target image is sometimes referred to as a target frame, and a reference image is sometimes referred to as a reference frame.

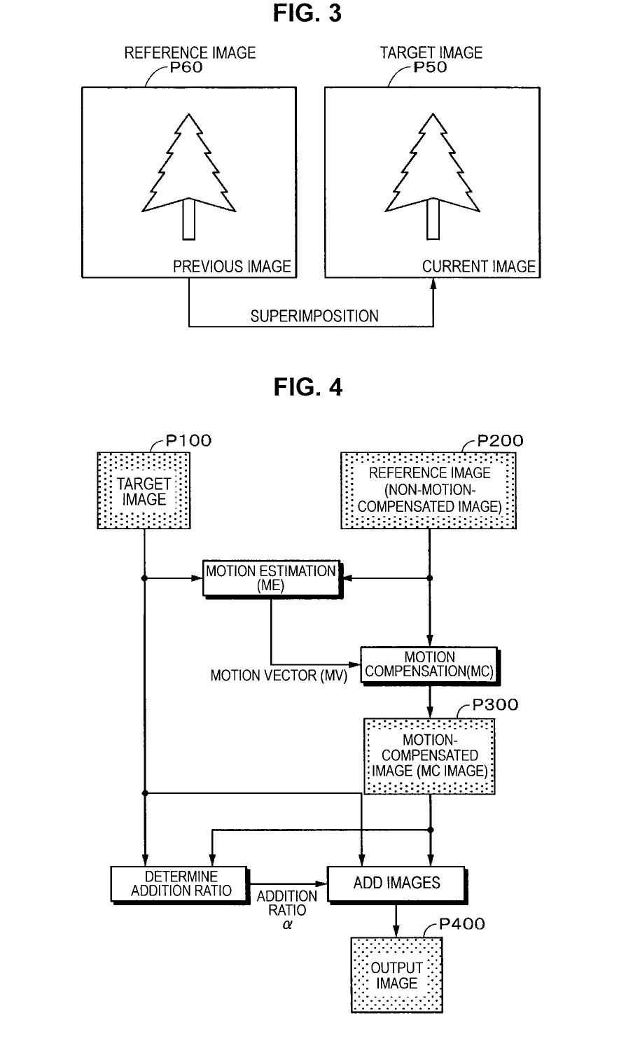

As an example, when an imaging device captures an image, each of images of continuous frames which are sequentially captured becomes a target image, as shown in FIG. 3. An image (for example, an image P60) of the previous frame of a target image (for example, an image P50) serves as a reference image and is superimposed on the target image. In other words, an image of a frame may be a target image, and may be a reference image when an image of another frame is a target image.

In this way, in the frame NR process where continuously captured images are superimposed, alignment in position (motion compensation) between target and reference images to be superimposed is important. In some cases, for these images, a displacement in an image position (image blur) may be occurred, for example, due to camera shake or the like of a photographer. Moreover, in some cases, for each image, the positional displacement is also occurred due to movement of a subject itself. Thus, in the frame NR process according to an embodiment, for example, for each of a plurality of target blocks generated by dividing a target image, a motion vector is estimated in units of blocks. Further, motion compensation that reflects a motion vector in units of blocks is performed for each block.

FIG. 4 illustrates an overview of a typical frame NR process. A target image P100 and a reference image P200 corresponding to the target image P100 are set. Motion estimation (ME) (sometimes referred to as motion detection) that compares the target image P100 with the reference image P200 and estimates its motion is performed. A motion vector (MV) is obtained by performing motion estimation. Motion compensation (MC) using a motion vector is performed on the reference image P200, and thus a motion-compensated image P300 is obtained.

An image addition process for adding the target image P100 and the motion-compensated image P300 is then performed. In the image addition process, an addition ratio determining process for determining the ratio of addition a in units of pixels may be performed. An output image P400 subjected to the frame NR process is obtained by performing the image addition process. The output image P400 becomes an image with reduced noise.

The reference image is sometimes referred to as non-motion-compensated image or non-motion-compensated frame because it is an image not subjected to the motion compensation process. In addition, an image (the motion-compensated image P300 in the example of FIG. 4) that is to be added to the target image is sometimes referred to as an image to be added or an image-to-be-added.

In the technique is disclosed in JP 2009-290827A mentioned above, when the reliability of a local motion vector is high, a motion-compensated image obtained from the local motion vector is used as an image to be added. In addition, when the reliability of a local motion vector is low, the local motion vector is not used, but a motion-compensated image obtained from a global motion vector is used as an image to be added. Thus, the frame NR process is intended to be stable.

In this regard, when a still image is captured, the dynamic range of pixel values will be constant to some extent by ISO sensitivity auto control. However, in the case where an image is captured in a dark place, the dynamic range may be reduced due to insufficient amount of light. When a moving image is captured, the dynamic range of pixel values is reduced due to the illuminance on a subject because the shutter speed is fixed, and accordingly, pixel values of an image recorded by the image capturing in a dark place become very small values.

Thus, in the technique is disclosed in JP 2009-290827A or the related art, it is very difficult to appropriately perform motion estimation when an image obtained by the image capturing in a dark place is used. In a typical motion estimation technology, on the assumption that the reliability of a motion vector is low when it is difficult to identify an object originally in a dark place or the like, a method in which the motion vector is not used has been employed. However, if such a method is applied to the frame NR process, then, for example, there are the following issues.

If an MC image is not generated in the frame NR process, the image addition is difficult to be performed. Thus, it is very difficult not to use a motion vector. Even if the reliability of a motion vector is low, it is necessary to generate any image to be added. For example, even when a reference image is used as it is for a portion (a block) in which the reliability of its motion vector is low, a portion added using an MC image and a portion added using a reference image are mixed in a screen, and thus the quality of a final image is not ensured.

For a portion in which the reliability of its motion vector is low, for example, it may be considered that an MC image is used by a global motion vector, but the reliability of the global motion vector is low at low illuminance originally.

The reliability of motion vector is determined by the degree of identification of an object in an input image, and thus there is a possibility that difference in final images is occurred depending on whether motion estimation is easily performed on the captured subject even when users capture an image in the same environment. Note that the degree of identification of an object means the ease of recognition of features of an object.

Furthermore, the hunting phenomenon occurs due to a threshold in which an effective motion vector is obtainable, and accordingly the frame NR process is enabled or disabled, thereby discontinuity in time of the process appears. In addition, although there is a technique for a robust motion estimation to cope with the lack of dynamic range, a user may capture an image a dark room originally, and thus, a motion vector may be not obtainable or the reliability thereof may be reduced. Although there is a technique that performs a process such as interpolation by introducing temporal continuity into estimation of a motion vector when the reliability of a motion vector is low, the reliability of the motion vector is kept low at low illuminance, and thus the interpolation will be unavailable. In an embodiment, an appropriate image to be added is generated to cope with the issues described above.

Table 1 below is intended to illustrate an example of the difference between an image of motion-compensated frame and an image of non-motion-compensated frame (reference frame) obtained by capturing an image at low illuminance and high illuminance.

TABLE 1

| | High Illuminance | Low Illuminance |
|---|---|---|
| Motion- | There is no time lag | There is a possibility |
| Compensated Frame | | that time lag is incapable |
| | | of being compensated |
| Non-Motion- | There are time lag | There are time lag |
| Compensated Frame | and afterimage | and afterimage |
| (reference image) | | |

As shown in Table 1, for a motion-compensated frame obtained by capturing an image at high illuminance, the accuracy of motion estimation is high and there is no time lag. Thus, when a motion-compensated frame serves as an image to be added and is added to a target image, time lag does not occur and an output image with reduced noise is obtained. On the other hand, when a non-motion-compensated frame obtained by capturing an image at high illuminance serves as an image to be added and is added to a target image, noise is reduced but the motion compensation is not performed, and thus time lag occurs and an afterimage is generated. In view of this fact, when an image is captured in a high illuminance environment, that is, when the level of image is large, it is preferable to use the motion-compensated frame as an image to be added.

Meanwhile, for a motion-compensated frame obtained by capturing an image at low illuminance, the accuracy of motion estimation is reduced and accordingly there is a risk that motion compensation is difficult to be performed properly. If such a motion-compensated frame is intended to be served as an image to be added and be added to a target image without any change, an output image in which time lag is difficult to be compensated is obtained. Actually, if the frame NR process is performed by changing target images sequentially, for example, a specific point of an output image is presented to a user as if it is blurred from side to side. The quality of an output image is significantly affected by failure of motion compensation.

When a non-motion-compensated frame obtained by capturing an image at low illuminance is added to a target image, time lag occurs and an afterimage is generated as is the case for high illuminance. However, the collapse of an output image is smaller than the case of adding a motion-compensated frame obtained by capturing an image at low illuminance to a target image. Furthermore, even when an afterimage occurs in a portion of an output image, the user feels that image capturing is performed in a low illuminance environment and then blurring occurs, and thus it can prevent the user who is viewing the output image from feeling a great sense of discomfort. In other words, in a low illuminance environment, it is preferable to generate an image to be added by blending a non-motion-compensated frame and a motion-compensated frame with an appropriate blending ratio σ.

Table 2 below is intended to illustrate an example of the features (reliability of motion estimation (ME)) of a motion-compensated frame.

TABLE 2

| | | Low Illuminance |
|---|---|---|
| | | (dynamic range of |
| | High Illuminance | input image is low) |
| Image having features | Reliability of ME: | Reliability of ME: |
| recognizable with ease | high | low |
| Image having features | Reliability of ME: | Reliability of ME: |
| recognizable with | low (but, it is | low |
| difficulty | capable of improve- | |
| | ment through global | |
| | MV, MV interpolation | |
| | in time direction or | |
| | the like) | |

The reliability of motion estimation of a motion-compensated frame at high illuminance varies depending on the property of an image. The reliability of motion estimation in a portion where features of an image are recognized with ease (for example, a portion where a subject exists) is high. On the other hand, the reliability of motion estimation in a portion where features of an image are recognized with difficulty (for example, a background portion) is low. However, it is possible to improve this issue by a process for using a global motion vector or for interpolating a motion vector in the time direction, or the like.

In the case of low illuminance, or when the dynamic range of an input image is low, the reliability of motion compensation is reduced. For this reason, regardless of the property of an image, a motion-compensated frame is not used as an image to be added, or an image obtained by increasing the blending ratio σ of a non-motion-compensated frame to a motion-compensated frame is used as an image to be added.

Note that illuminance is measured, for example, in units of lux ([lux] or [lx]). The illuminance may be defined in another unit of measurement. Furthermore, the present disclosure is not intended to be limited to a process divided into two luminance levels, low luminance and high luminance.

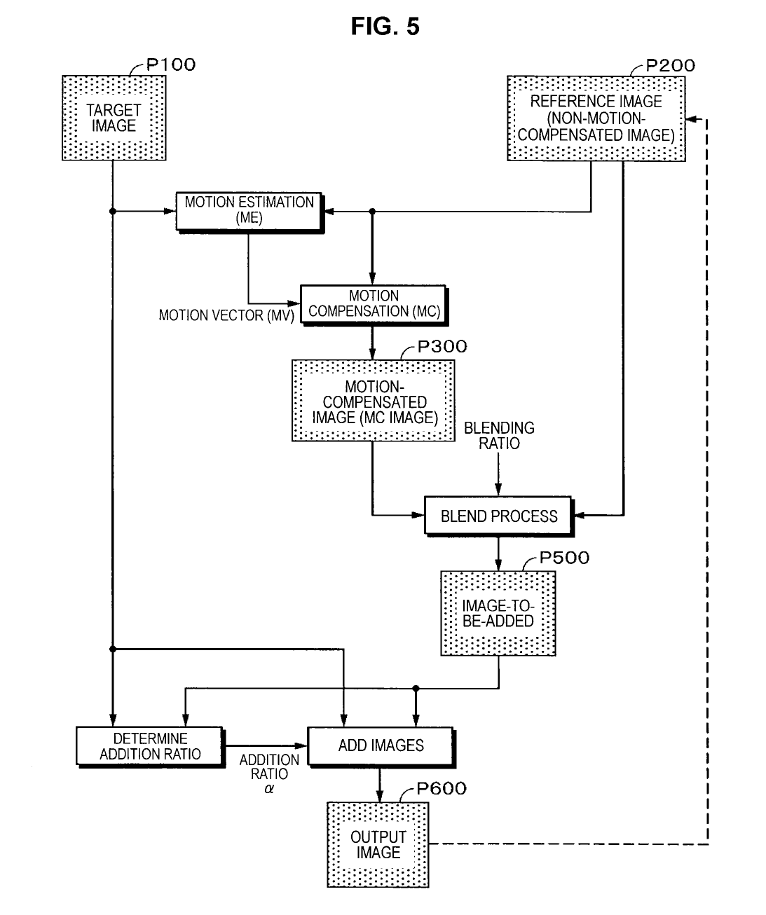

In view of the above, an example of an overview of an embodiment is illustrated in FIG. 5. A process of obtaining a motion vector that performs motion estimation by using the target image P100 and the reference image P200 and a process of obtaining the motion-compensated image P300 that performs motion compensation by using the motion vector are similar to a typical NR frame process.

A blending process for blending the motion-compensated image P300 that is an example of the first image and the reference image P200 that is an example of the second image by a predetermined blending ratio σ is performed. As a result of performing the blending process, an image-to-be-added P500 is generated as an example of the third image. The blending ratio σ indicates, for example, the proportion of the reference image P200 to the motion-compensated image P300. The blending ratio may be defined by the proportion of the motion-compensated image P300 to the reference image P200. If the blending ratio σ is zero, then the image-to-be-added P500 becomes the motion-compensated image P300 itself. If the blending ratio σ is 100, then the image-to-be-added P500 becomes the reference image P200 itself. The blending ratio σ is determined appropriately, for example, depending on the brightness (level) of an input image. As an example, the blending ratio σ is set to be smaller as the brightness is increased.

The image addition process for adding the target image P100 and the image-to-be-added P500 is then performed. An addition ratio determination process for determining the addition ratio σ in units of pixels may be performed in the image addition process. The image addition process makes it possible to obtain an output image P600 subjected to the frame NR process. The frame NR process according to an embodiment makes it possible to obtain the output image P600 with reduced noise and to prevent deterioration of image quality due to the inaccuracy of motion estimation or the like. The output image P600 is set as a reference image with respect to the subsequent target image.

[Flow of Process According to Embodiment]

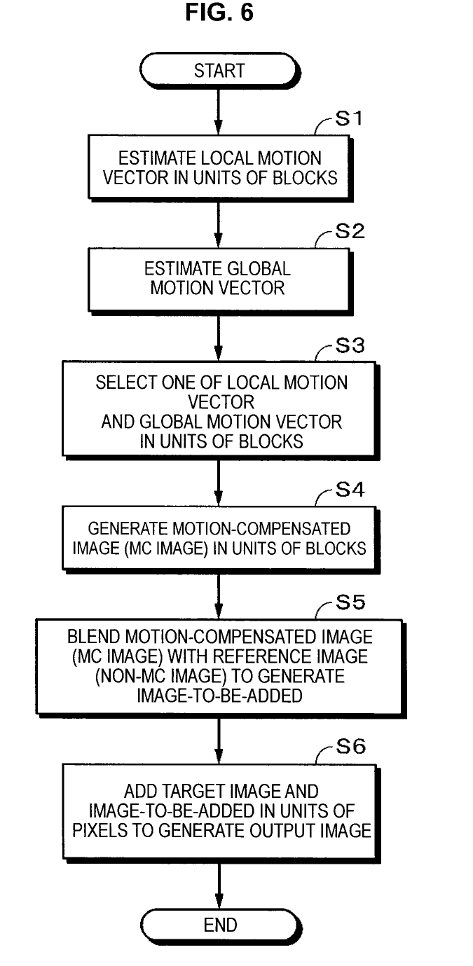

FIG. 6 is a flowchart showing a flow of the main process according to an embodiment. The process shown in FIG. 6 is, for example, implemented as a software process. The details of each process and an example of a hardware configuration for implementing the process to be described below are described later.

In step S1, a target frame is divided into blocks of p×q pixels. A local motion vector is estimated for each of the divided blocks. Then, the process proceeds to step S2.

In step S2, a global motion vector is estimated for each block. Then, the process proceeds to step S3.

In step S3, any of the local motion vector and the global motion vector is selected in units of blocks. Then, the process proceeds to step S4.

In step S4, a motion-compensated image is generated in units of blocks. A vector to be used when performing motion compensation is the local motion vector or the global motion vector determined in step S3. Then, the process proceeds to step S5.

In step S5, the motion-compensated image and a reference image are blended with each other by a predetermined blending ratio σ, and thus an image-to-be-added is generated. The blending ratio σ is set, for example, depending to the brightness of an input image. Then, the process proceeds to step S6.

In step S6, an output image is generated, for example, by adding the image-to-be-added to a target image for each pixel. The generated output image is used as a subsequent reference image. Step S1 and the subsequent steps are repeated until the process is completed for all of the target images.

[Estimation of Motion Vector and Evaluation of Reliability of Motion Vector]

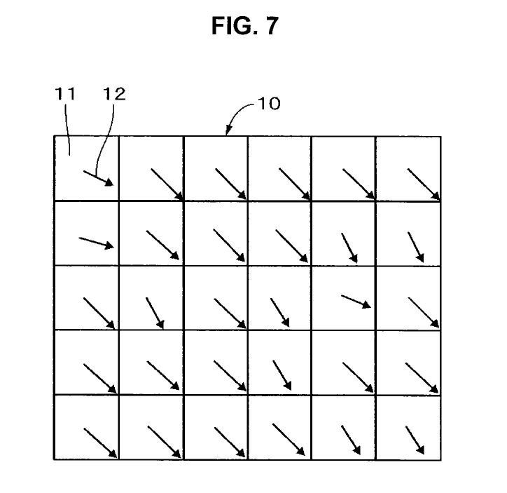

In an embodiment, one screen is divided into a plurality of blocks. As shown in FIG. 7, a target frame 10 is divided into, for example, target blocks 11 that consist of 64 pixels×64 lines. A motion vector is estimated for each target block 11. A motion vector estimated for each target block is appropriately referred to as a local motion vector (LMV). The local motion vector may be estimated by means of other approaches. The local motion vector 12 is estimated for each target block 11. Furthermore, in an embodiment, an index indicating the reliability of each of the estimated local motion vectors 12 is calculated.

In this regard, a block matching algorithm is used in a process for estimating a motion vector for each block. In such a block matching algorithm, for example, a block having the highest correlation with a target block is searched from among each block of a reference image. Each block of a reference image is appropriately referred to as a reference block. A reference block having the highest correlation with a target block is appropriately referred to as a motion-compensated block.

The local motion vector 12 is obtained as a displacement in position between the target block and the motion-compensated block. The height of correlation between the target block and the reference block is evaluated, for example, by the sum of absolute differences (SAD) of a luminance value for each pixel in both the blocks. The correlation is higher as the SAD value is smaller. A table that stores a SAD value for each of the target blocks or the reference blocks is appropriately referred as a SAD table.

A local motion vector 12 having high reliability is then extracted from among a plurality of local motion vectors 12 obtained for the target frame based on the index indicating the reliability of the local motion vector 12.

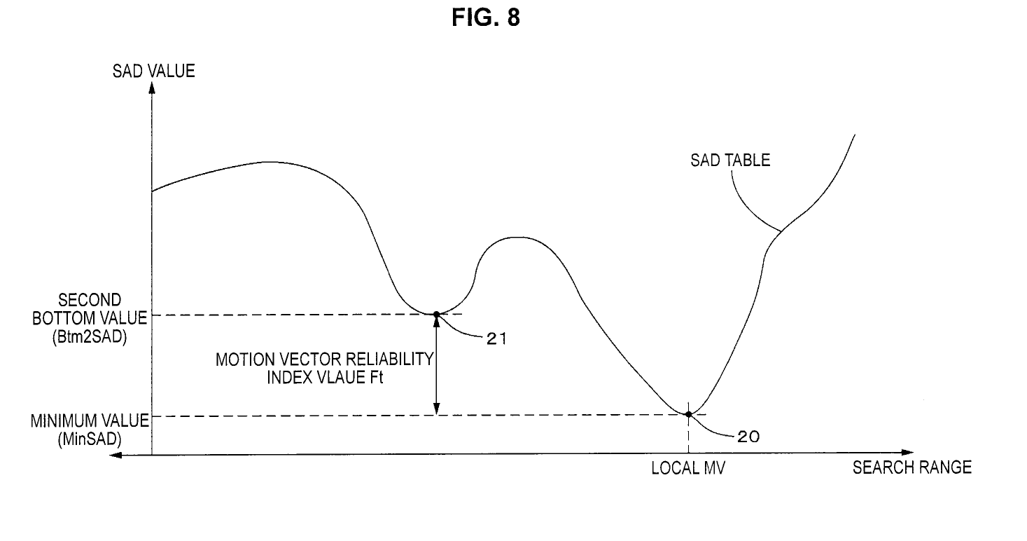

An example of a method of evaluating the reliability of a motion vector (the local motion vector 12 in this example) is described with reference to FIG. 8. FIG. 8 illustrates schematically a SAD value in the SAD table for one target block. In FIG. 8, the horizontal axis represents a search range and the vertical axis represents a SAD value.

In a typical block matching process, only a minimum value of SAD values in the SAD table is to be estimated to estimate a motion vector. The minimum value of SAD values is the first bottom value of the SAD values in the SAD table and is located at the position indicated by a point 20 in FIG. 8. A motion vector (local motion vector 12) is estimated as a vector pointing from the origin of motion to the position of the minimum value of the SAD values indicated by the point 20.

In an ideal state free from noise, when a correlation value between a plurality of reference and target blocks within a search range is obtained, the SAD table has a uniformly downwardly convex shape and it becomes a state where there is only one bottom value of the SAD values. However, in an actual image capturing situation, there is scarcely a case where the SAD table has a uniformly downwardly convex shape and it is common that there are a plurality of bottom values among the SAD values, because of various types of noise in addition to change in light quantity or influence of motion of a moving object.

Thus, in this exemplary embodiment, a motion vector is estimated based on the position of a reference block which exhibits the first bottom value equal to the minimum value of the SAD values, but a bottom value excluding the first bottom value among the SAD values, that is, a second bottom value of the SAD values is estimated to generate the index of reliability. In FIG. 8, the position indicated by the point 20 represents the first bottom value and the position indicated by a point 21 represents the second bottom value.

In an embodiment, a difference value between the first bottom value (MinSAD) and the second bottom value (Btm2SAD) is set as an index value Ft indicating the reliability of motion vector. In other words, the index value Ft is given, for example, by the following Equation (1).

Ft=MinSAD−Btm2SAD (1)

If the influence of noise or the like is small, the index value Ft that is the difference between the first bottom value of the SAD values and the second bottom value of the SAD values is increased, and the reliability of a motion vector estimated from the first bottom value of the SAD values, that is the minimum value of the SAD values is high. On the other hand, in an environment with a high level of noise or the like, the index value Ft is reduced, and thus it becomes a situation where it is difficult to know which one corresponds properly to a motion vector, thereby leading to reduced reliability.

In the case where the first bottom value of the SAD values is obtained but the second bottom value of the SAD values is not obtained, a theoretical maximum value of the SAD values or a maximum value of the SAD values in the SAD table may be used as an index value indicating the reliability of a motion vector. Thus, a motion vector of such a block has high reliability, but there is little, if any, of such a block. Accordingly, a motion vector of a block obtained in the case where the first bottom value of the SAD values is obtained but the second bottom value of the SAD values is not obtained may be excluded from evaluation of reliability.

Instead of the difference between the first bottom value of the SAD values and the second bottom value of the SAD values, the ratio between the first bottom value of the SAD values and the second bottom value of the SAD values may be used as an index value indicating reliability of a local motion vector.

According to an embodiment employing an index indicating the reliability of a motion vector, a correlation value between a target frame and a reference frame is used without using an image component such as an edge or features of an image as in the past, thereby achieving high robustness against noise. In other words, it is possible to obtain an index indicating reliability of a motion vector with high accuracy without being affected by noise of an image.

Moreover, the difference or ratio between the first top value of the correlation value (e.g., first bottom value of the SAD values) and the second top value of the correlation value (e.g., second bottom value of the SAD values) is used, and thus an index indicating reliability of a motion vector has high robustness against noise.

In other words, in a case where a noise level becomes higher, even if a motion vector were appropriate, the SAD value is typically increased. Thus, when a threshold is set with respect to the index value Ft indicating the reliability of motion vector and a process for comparing the index value with the threshold is performed for the purpose of extracting a motion vector having high reliability, it is necessary to change the threshold itself depending on its noise level.

On the contrary, when the index value Ft indicating the reliability of motion vector according to an embodiment is used, if the noise level is high, then both the first and second bottom values of the SAD values are increased depending on the noise level. Thus, the influence of noise on the difference between the first bottom value of the SAD values and the second bottom value of the SAD values is cancelled out.

In other words, it is possible to process a threshold having a fixed value without depending on a noise level. The same is true when the ratio between the first bottom value of the SAD values and the second bottom value of the SAD values is used as the index value Ft indicating the reliability of motion vector.

As illustrated, the reliability of each of the local motion vectors 12 is evaluated. A global motion is calculated from only the local motion vector 12 with high reliability. A global motion vector is calculated for each target block by using the calculated global motion. The global motion vector is a motion vector corresponding to motion in the entire screen.

[Selection of Motion Vector According to Features of Image]

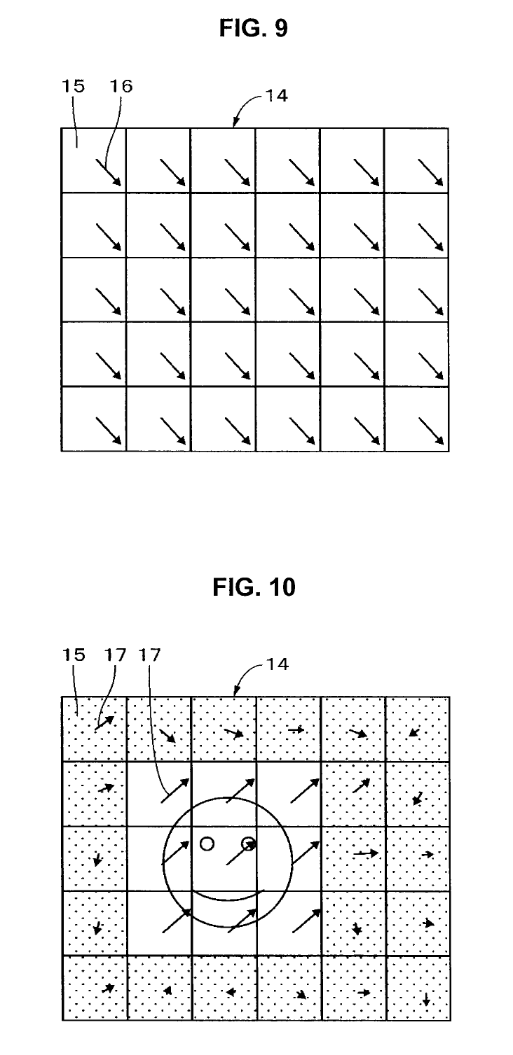

FIG. 9 illustrates a global motion vector 16 for each target block 15 of a target frame 14. FIG. 10 illustrates a local motion vector 17 for each target block 15 of the target frame 14. Only a portion of motion vectors (indicated by arrow) is denoted with a reference numeral to prevent the illustration from being complicated.

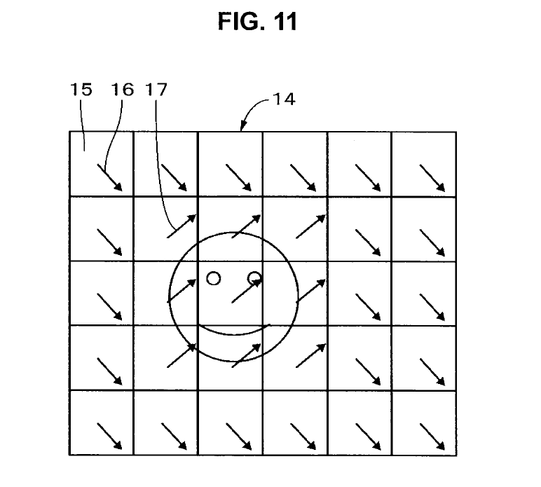

As shown in Table 2 above, in a portion where features of an image are recognized with ease (for example, a portion where a moving subject exists), the reliability of motion estimation is high and the reliability of motion vector is high. On the other hand, in a portion where features of an image are recognized with difficulty (for example, a background portion), the reliability of motion estimation is low and the reliability of motion vector is low. In FIG. 10, the reliability of each local motion vector of the hatched background portion is low. Thus, in an embodiment, as shown in FIG. 11, a local motion vector is set as a motion vector for the NR process for blocks where a moving subject exists in the screen. A global motion vector is set as a motion vector for the NR process for a background portion. The set motion vector for the NR process is used in the process for generating a motion-compensated image.

A process for discriminating between a background portion and a moving subject by comparing the calculated global motion vector with the local motion vector for each target block will be described as an example. In an embodiment, the calculated global motion vector and the local motion vector for each target block are compared with each other, and thus the degree of matching between both vectors is determined. As a result of the determination, an index value indicating the degree of matching between the global motion vector and the local motion vector for each target block is calculated. This index value is appropriately referred to as a hit rate.

Such evaluation and determination are performed in consideration of the influence of noise included in an image on the correlation value calculated in a block matching process.

When, for a target block, its global motion vector and its local motion vector are matched with each other, it can be determined that the target block is a background image portion. Thus, an index value of this degree of matching indicates the degree of whether an image of the target block is matched with the background image portion (a background matching degree).

In this regard, if the global motion vector and the local motion vector are not matched with each other, it may be determined that all of the target blocks are portions of a moving subject if image noise is not considered. In this case, the SAD value for the reference block corresponding to the local motion vector becomes a minimum, which is smaller than the SAD value for the reference block corresponding to the global motion vector.

However, an image such as a captured image typically contains noise. In consideration of such image noise, even when a global motion vector and a local motion vector are not matched with each other, a target block may sometimes be a background portion. Thus, in such a target block, it is considered that the difference between the SAD value for a reference block corresponding to the local motion vector and the SAD value for a reference block corresponding to the global motion vector is smaller than the amount of the image noise.

Thus, in an embodiment, the SAD value for a reference block corresponding to the global motion vector is corrected to a value that reflects the amount of the image noise, and then the corrected SAD value is compared with the SAD value for a reference block corresponding to the local motion vector. Then, when the corrected SAD value is small, the target block is evaluated to be a background image portion. In other words, in an embodiment, the background matching degree is evaluated based on the corrected SAD value. In this case, it is considered that the global motion vector matches an original local motion vector for the target block.

If it is determined that the target block is a background image portion based on the result of evaluating the background matching degree, then the global motion vector is outputted as a motion vector for the NR process for the target block. On the other hand, if it is determined that the target block does not match a background image portion based on the result of evaluating the background matching degree, then the local motion vector is outputted as a motion vector for the NR process for the target block.

It should is noted that, if the global motion vector and the local motion vector fully match with each other, then any of the global motion vector and the local motion vector may be used as a motion vector for the NR process.

The reference frame is then aligned in units of blocks for a target frame by using the motion vector for the NR process for each target block, and thus a motion-compensated image (motion-compensated frame) is generated. All of the motion vectors for the NR process may be the global motion vector or the local motion vector. In other words, a motion-compensated image can be obtained by using at least one of the global motion vector and the local motion vector.

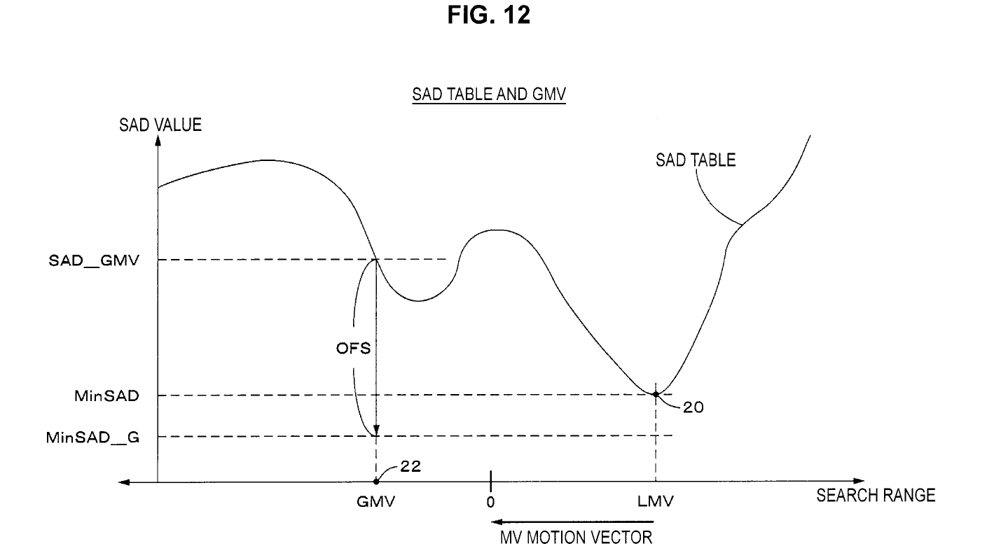

FIG. 12 is a diagram for explaining an example of a method of discriminating between a background and a moving subject. FIG. 12 is a diagram representing contents (SAD value) of an SAD table for a single target block when the horizontal axis represents a search range and the horizontal axis represents an SAD value. Each value on the horizontal axis is the position of a reference block (reference vector) and the solid line represents contents of the SAD table. These are similar to those shown in FIG. 8.

In FIG. 12, the position 20 of a reference block (i.e., a reference vector) that will be the minimum SAD value is estimated as a local motion vector by the block matching in a similar way to FIG. 8. On the other hand, the position of a reference block that will be a global motion vector is a position 22 in FIG. 12.

In this case, if the SAD value in the local motion vector and the SAD value in the global motion vector are within the range of the difference corresponding to the amount of image noise, there is a possibility that the global motion vector is a reference vector having the minimum SAD value.

In other words, the SAD value for the global motion vector (position of reference block) should have been a minimum value, but there is a possibility that the position of another reference block (this is the local motion vector) is mistakenly estimated as a minimum value because of noise.

Thus, in this example, an offset value OFS corresponding to the amount of image noise is added to the SAD value for the global motion vector, thereby performing the correction. In the case of this example, the correction is performed by subtracting the offset value OFS from the SAD value for the global motion vector (referred to as SAD_GMV). If the corrected SAD value is set to MinSAD_G, the MinSAD_G is given by the following Equation (2).

MinSAD_{—}G=SAD_{—}GMV−OFS (2)

The corrected SAD value MinSAD_G and the SAD value for the local motion vector (MinSAD) are compared with each other. As the result of the comparison, if MinSAD_G<MinSAD, then the minimum value of the SAD values for the target block is evaluated to be MinSAD_G that is a corrected value of the SAD value for a reference block corresponding to the global motion vector. FIG. 12 shows a case where MinSAD_G<MinSAD.

As shown in FIG. 12, if the condition of MinSAD_G<MinSAD is satisfied, a true local motion vector for the target block is determined to be matched with a global motion vector. In this case, the background matching degree for the target block is evaluated to be high, and the hit rate β is a large value. A motion vector for the NR process for the target block is set to a global motion vector. Otherwise, a motion vector for the NR process is set to a local motion vector.

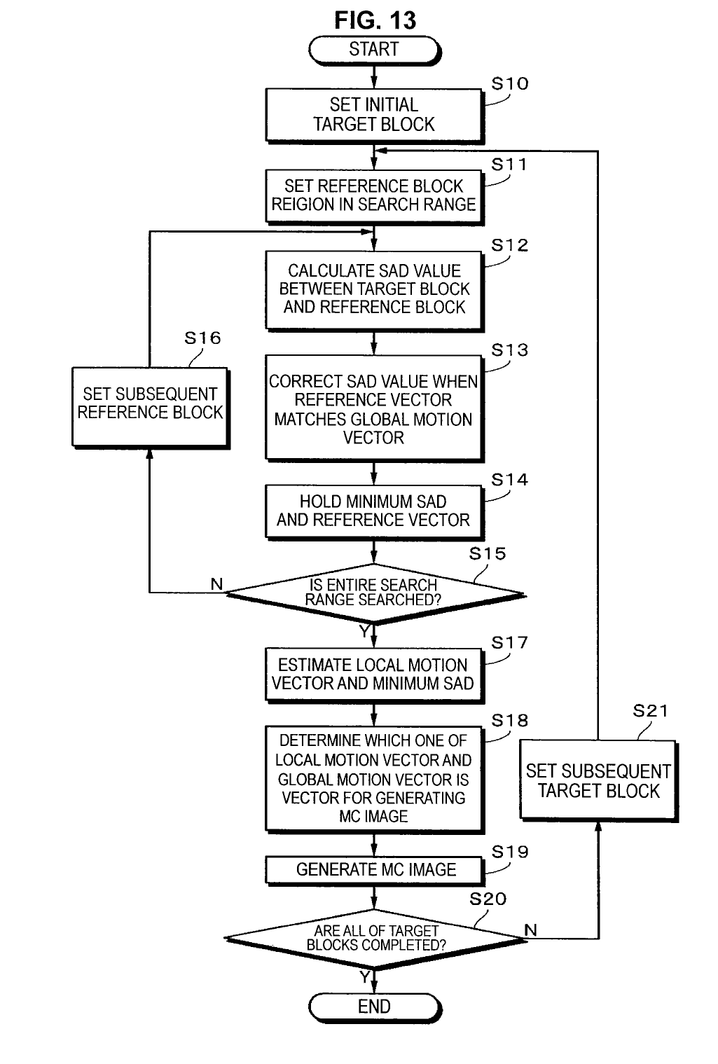

A flowchart summarizing an example of the flow of the processing described above illustrates in FIG. 13. In step S10, an initial target block is set. Then, the process proceeds to step S11.

In step S11, a reference block to be subjected to the block matching process is set from among image data of a reference frame in the matching process range. Then, the process proceeds to step S12.

In step S12, the block matching process for the set target block and the set reference block is performed, and an SAD value is calculated. The calculated SAD value is outputted together with position information of the reference block (reference vector). Then, the process proceeds to step S13.

In step S13, it is determined whether the reference vector matches the global motion vector. If it is determined that the reference vector matches the global motion vector, then the process of subtracting an offset value OFS from SAD_GMV that is an SAD value of the global motion vector is performed. Then, a result obtained from the subtraction is held as MinSAD_G that is the corrected SAD value together with the position of the reference block (reference vector=global motion vector). If it is determined that the reference vector does not match the global motion vector, then the process proceeds to step S14.

In step S14, the process of updating a minimum SAD value MinSAD and the position of the reference block thereof (reference vector) is performed. That is, the minimum SAD value MinSAD held until then is compared with a newly calculated SAD value, and then the SAD value smaller than other SAD value is held as a minimum SAD value MinSAD, and at the same time, the position of the reference block (reference vector) is also updated to exhibit a minimum SAD value. Then, the process proceeds to step S15.

In step S15, it is determined whether the block matching process for all of the reference blocks in a search range with the target block is completed. If it is determined that the block matching process for all of the reference blocks in a search range is not completed, then the process proceeds to step S16 and a subsequent reference block is set. Then, the process returns to step S12, and step S12 and the subsequent steps are repeated. In step S15, if it is determined that the block matching process for all of the reference blocks in a search range is completed, then the process proceeds to step S17.

In step S17, a local motion vector and a minimum SAD value MinSAD are estimated. In addition, the corrected SAD value MinSAD_G is also estimated. Then, the process proceeds to step S18.

In step S18, the minimum SAD value MinSAD and the corrected SAD value MinSAD_G are compared with each other. As a result of the comparison, if it is determined that the condition of MinSAD>MinSAD_G is not satisfied, then it is determined that a target block does not match a background. In this case, a local motion vector is decided and outputted as a motion vector for the NR process of the target block.

Furthermore, in step S18, if it is determined that the condition of MinSAD>MinSAD_G is satisfied, it is determined that the degree of matching between the target block and a background is high. In this case, a global motion vector is decided and outputted as a motion vector for the NR process of the target block. Then, the process proceeds to step S19.

In step S19, based on the local motion vector or the global motion vector decided in step S18, a motion-compensated image (MC image) is generated. Then, the process proceeds to step S20.

In step S20, it is determined whether the process for all of the target blocks within the target frame is completed. If it is determined that the process for all of the target blocks within the target frame is not completed, then the process proceeds to step S21 and a subsequent target block is set. Then, the process returns to step S11, and step S11 and the subsequent steps are repeated.

Furthermore, in step S20, if it is determined that the process for all of the target blocks within the target frame is completed, then the series of processes are terminated.

[Process of Estimating Motion Vector According to Embodiment]

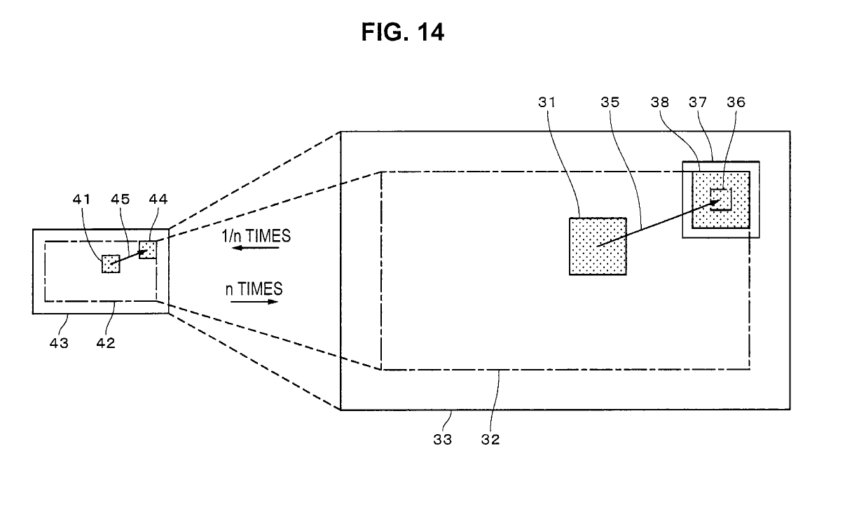

FIG. 14 is a diagram for explaining a motion vector estimation process according to an embodiment. Referring to FIG. 14, in the motion vector estimation process according to an embodiment, a motion vector in a reduced screen is initially estimated, and, based on the result thereof, a motion vector in a base plane is estimated.

In the process of estimating a motion vector in units of blocks, a reference block indicating a minimum SAD value is specified as a motion-compensated block. In other words, so as to specify a motion-compensated block, it is necessary to search a reference block indicating a minimum SAD value while sequentially shifting the position of a reference block. As an example, when it is intended to estimate a motion vector having the accuracy of one pixel, it is necessary to specify a motion-compensated block with the accuracy of one pixel. Thus, even when a reference block indicating a minimum SAD value is searched, it is necessary to sequentially shift the reference block in units of one pixel.

In a case where such search of a reference block is performed for a target image and a reference image without any change, the number of times of calculation of an SAD value becomes large, thereby increasing the processing load. Thus, in an embodiment, as in the example illustrated, an image (a reduced plane) obtained by reducing in size each of the target image and the reference images is produced, and a motion vector in a target image and a reference image (base plane) that are not reduced is estimated based on the result obtained by estimating a motion vector in the reduced plane.

More specifically, initially, each of the target image and the reference image is reduced in size by 1/n (where n=2, 3, . . . ) in both the horizontal and vertical directions, and then a reduced-plane target image and a reduced-plane reference image are produced. Thus, a base-plane target block 31, a search range 32, and a matching processing range 33 are reduced in size by 1/n, resulting in a reduced-plane target block 41, a reduced-plane search range 42, and a reduced-plane matching processing range 43, respectively. The search range 32 and the matching processing range 33 are set based on an image projected to a reference image of the base-plane target block 31.

Subsequently, in the reduced-plane reference image, an SAD value between a plurality of reduced-plane reference blocks 44 set in the reduced-plane matching processing range 43 and the reduced-plane target block 41 is calculated, and thus a block having the highest correlation with the reduced-plane target block 41 among the reduced-plane reference blocks 44 is specified as a reduced-plane motion-compensated block. Further, a displacement in position between the reduced-plane target block 41 and the reduced-plane motion-compensated block is acquired as a reduced-plane motion vector 45.

Next, in the base-plane reference image, a base-plane temporary motion vector 35 obtained by multiplying the reduced-plane motion vector 45 by n is defined. Further, in the vicinity of the position where the base-plane target block 31 is shifted by the amount of the base-plane temporary motion vector 35 from an image projected to the base-plane reference image, a base-plane search range 36 and a base-plane matching processing range 37 are set. Subsequently, an SAD value between a plurality of base-plane reference blocks 38 set in the base-plane matching processing range 37 and the base-plane target block 31 is calculated. Thus, a block having the highest correlation with the base-plane target block 31 among the base-plane reference blocks 38 is specified as a base-plane motion-compensated block. Further, a displacement in position between the base-plane target block 31 and the base-plane motion-compensated block is acquired as a base-plane motion vector.

In this regard, the reduced-plane reference image is reduced in size to 1/n as compared with the base-plane reference image, and thus the reduced-plane motion vector 45 has the accuracy that is n times lower than that obtained by the search of a similar way in the base plane. For example, in a case where a motion vector is obtained by searching a motion-compensated block while sequentially shifting a reference block in units of one pixel, the accuracy of a motion vector obtained from the search in the base plane is one pixel, but the accuracy of a motion vector obtained from the search in the reduced plane is n pixels.

Therefore, in an embodiment, based on the reduced-plane motion vector 45 obtained by the search in the reduced plane, the base-plane search range 36 and the base-plane matching processing range 37 are set in the base-plane reference image, and the search for a motion-compensated block a and motion vector with a desired accuracy is performed. The range where its accuracy is n times lower but a motion-compensated block can exist is specified by the reduced-plane motion vector 45. For this reason, the range of search for the base plane may be the base-plane search range 36 which is much smaller in size than the original search range 32. For example, in the illustrated example, when a motion vector is obtained in units of one pixel by the search for the base plane, the base-plane search range 36 may be the range of n pixels in both the horizontal and vertical directions.

In the motion vector estimation process according to an embodiment, the search for a motion-compensated block in the entire original search range 32 is replaced by the search in the reduced-plane search range 42. Thus, the number of times of calculation of an SAD value for the reference block is reduced, for example, to 1/n, as compared with the case where a target image and a reference image are used without any change. Furthermore, in the motion vector estimation process according to an embodiment, an additional search in the base-plane search range 36 is performed, but the base-plane search range 36 will be much smaller than the original search range 32. However, the number of times of calculation of an SAD value for the reference block in such additional search is small. Thus, in the motion vector estimation process according to an embodiment, the processing load is reduced as compared with the case where a target image and a reference image are used without any change.

As described above, in the frame NR process according to an embodiment, a plurality of images continuously shot are motion compensated and then superimposed, thereby reducing noise of an image. Estimation of a motion vector for motion compensation is performed with reduced processing load by the search using a reduced plane in which a base plane is reduced in size.

[Generation of Image to be Added]

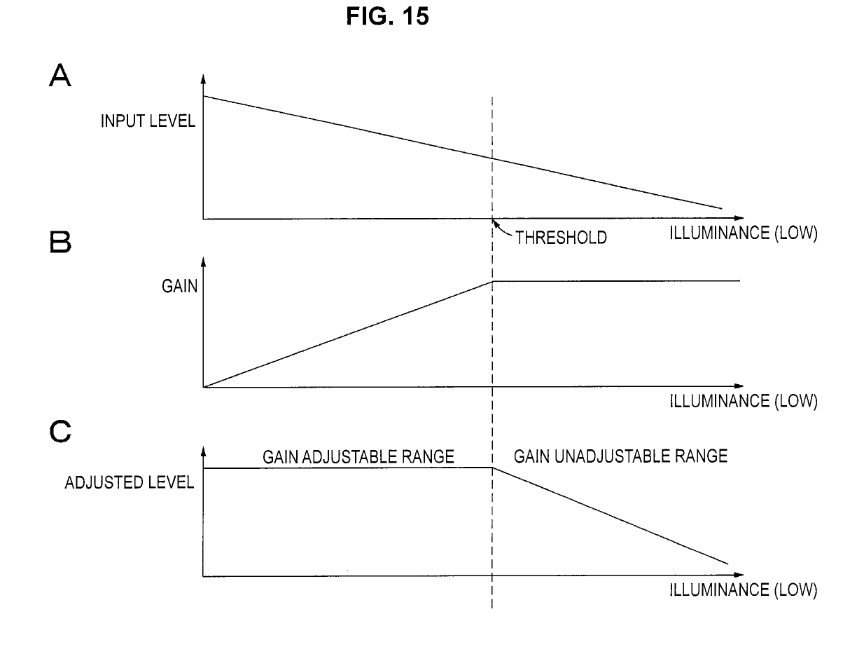

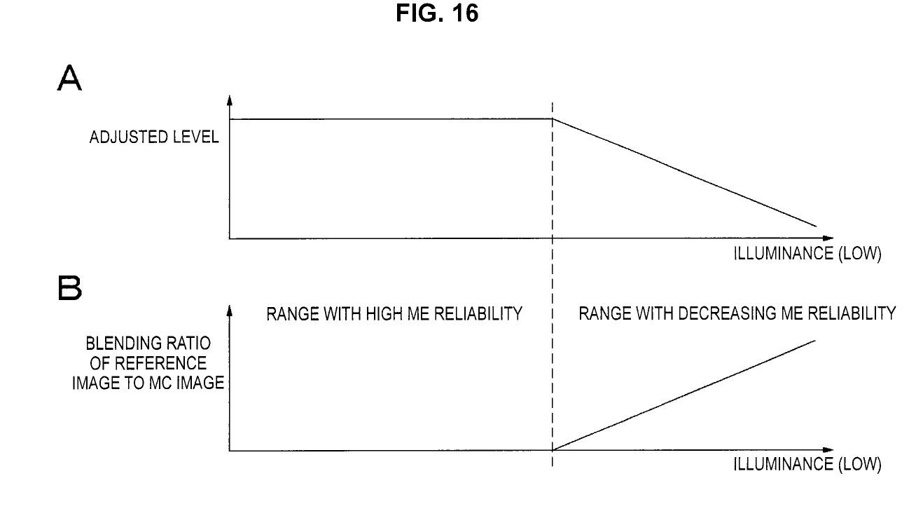

Subsequently, a process of generating an image to be added (the process of step S5 in FIG. 6) will be described. FIG. 15A illustrates an example of change in the level of an input image corresponding to the illuminance. In FIG. 15A, the horizontal axis represents illuminance at the time of capturing, and the vertical axis represents the level of an input image. As the illuminance becomes lower, for example, the level of an input image decreases substantially linearly.

A process of adjusting gain in an imaging device is performed to compensate for the decrease of the level of an input image. FIG. 15B illustrates an example of gain adjustment. The control of increasing the gain is performed until the illuminance reaches a fixed value. In this example, a certain value of illuminance is set as a threshold. When illuminance is lower than the threshold, the level of gain is set such that the level of gain is not greater than the threshold.

FIG. 15C illustrates an example the level of an input image corrected by gain adjustment (referred appropriately to as an adjusted level). In a range where illuminance is greater than a threshold (range capable of gain adjustment), the level of an input image is adjusted such that the adjusted level is substantially constant. In a range where illuminance is smaller than the threshold (range incapable of gain adjustment), the adjusted level decreases.

FIG. 16A is a diagram similar to FIG. 15C. As described above, during a period of time when illuminance is high, the reliability of motion estimation is high. Thus, a threshold for illuminance is set as shown in FIG. 16B. In a range where illuminance is greater than the threshold, that is, the brightness of an input image is greater than a predetermined level, the blending ratio σ of a reference image to an MC image is set to zero. In other words, the MC image itself is set as an image to be added.

In a range where the reliability of motion vector is lowered (for example, a range where illumination is lower than a threshold, that is, brightness of an input image is lower than a predetermined level), the blending ratio σ of a reference image to an MC image is set to be increased. In FIG. 16B, it is illustrated that the blending ratio σ of a reference image to an MC image is set to be increased linearly, but the blending ratio is not limited thereto. For example, the blending ratio σ may be set to be increased in a stepwise manner, and may be set to be increased like a quadratic curve. The MC image and the reference image are blended with each other and an image to be added is generated, based on the set blending ratio σ. The image to be added is added to a target image, resulting in obtaining an output image.

[Overall Configuration of Imaging Device]

An overview of the process according to an embodiment and details of the process have been described. An exemplary hardware configuration for implementing the process will now be described.

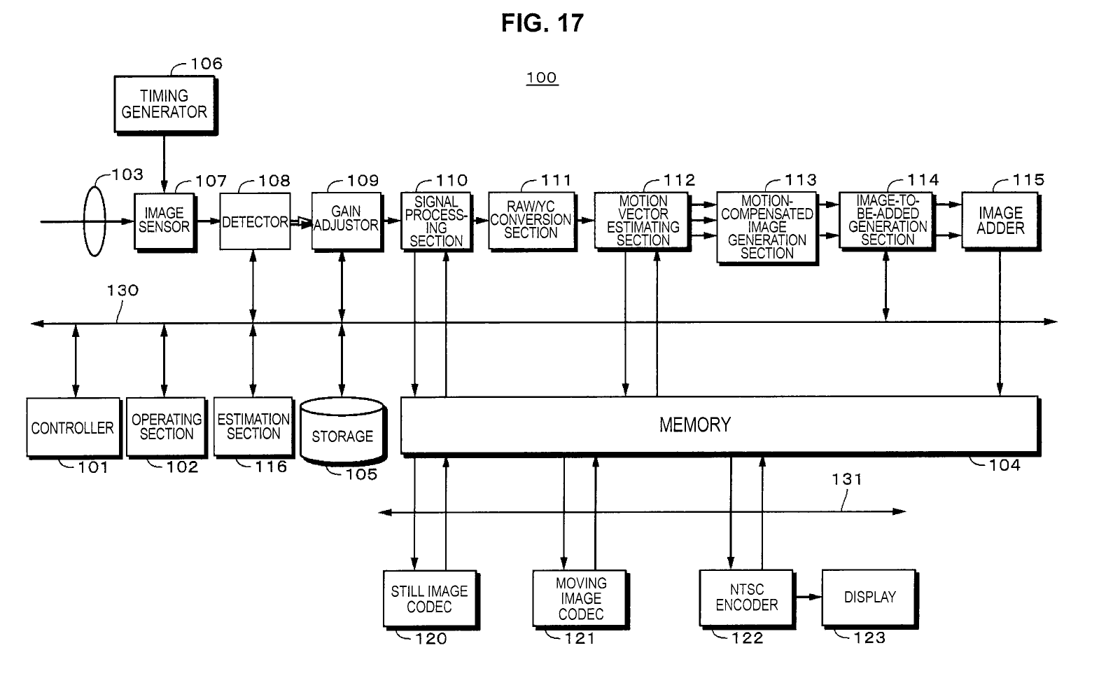

FIG. 17 illustrates an example of the overall configuration of an imaging device. The imaging device 100 may be an electronic apparatus such as a digital camera which has functions of capturing still or moving images, converting the captured image into digital image data, and recording the data on a recording medium. The imaging device corresponds to an illustrative example of an image processing device that includes at least an image-to-be-added generation unit. An example of the image processing device is not limited to an imaging device, and the image processing device may be incorporated into an electronic apparatus such as a personal computer.

The imaging device 100 includes a controller 101, an operating section 102, an imaging optical system 103, a memory 104, a storage 105, a timing generator 106, an image sensor 107, a detector 108, a gain adjustor 109, a signal processing section 110, an RAW/YC conversion section 111, a motion vector estimating section 112, a motion-compensated image generation section 113, an image-to-be-added generation section 114, an image adder 115, an estimation section 116, a still image codec 120, a moving image codec 121, an NTSC encoder 122, and a display 123. Each of these components is interconnected via a system bus 130 or a system bus 131. Data or command can be exchanged between them via the system bus 130 or the system bus 131.

The controller 101 controls the operation of each component of the imaging device 100. The controller 101 includes a CPU (Central Processing Unit) that executes various operation processes necessary for the control, for example, by performing an operation based on a program stored in the memory 104. The controller 101 may use the memory 104 as a temporary storage region for an operation process. The program for allowing the controller 101 to work may be previously written in the memory 104, or may be stored in a disk-shaped recording medium or a removable recording medium such as memory card and then provided to the imaging device 100. In addition, the program for allowing the controller 101 to work may be downloaded to the imaging device 100 over a network such as LAN (Local Area Network) or Internet.

The controller 101 acquires, for example, detection information indicating the brightness of an input image from the detector 108. The controller 101 then appropriately controls the gain adjustor 109 to adjust gain based on the obtained detection information. Further, the controller 101 appropriately set the blending ratio σ of a reference image to an MC image based on the obtained detection information. In other words, the controller 101 functions as the blending ratio setting unit in the appended claims. The controller 101 may set the blending ratio σ based on the adjusted level.

The operating section 102 functions as a user interface which is used to operate the imaging device 100. The operating section 102 may be operating buttons such as a shutter button provided on the exterior of the imaging device 100, a touch panel, a remote controller, or the like. The operating section 102 outputs an operating signal to the controller 101 based on the user's operation. The operating signal includes startup and stop of the imaging device 100, start and end of capturing of still or moving images, setting of various functions of the imaging device 100, or the like.

The imaging optical system 103 includes optical components including various types of lenses such as focus lens and zoom lens, an optical filter, or a diaphragm. An optical image incident from a subject (a subject image) passes through each optical component of the imaging optical system 103 and then is formed on the exposed surface of the image sensor 107.

The memory 104 stores data that is related to the process to be performed by the imaging device 100. The memory 104 is composed of, for example, a semiconductor memory such as flash ROM (Read Only Memory), DRAM (Dynamic Random Access Memory), or the like. The program to be used by the controller 101 and the image signal to be processed by an imaging processing function are stored, for example, in the memory 104 in a temporary or permanent manner. The image signal stored in the memory 104 may be a target image, a reference image, and an output image on a base plane and a reduced plane described later.

The storage 105 stores an image captured by the imaging device 100 in the form of image data. The storage 105 may be, for example, a semiconductor memory such as flash ROM, an optical disc such as BD (Blu-ray Disc (registered trademark)), DVD (Digital Versatile Disc) or CD (Compact Disc), a hard disk, or the like. The storage 105 may be a storage device incorporated in the imaging device 100, or may be a removable medium detachable from the imaging device 100, such as a memory card.

The timing generator 106 generates various types of pulses such as a four-phase pulse, a filed shift pulse, a two-phase pulse, and a shutter pulse, and then supplies one or more of these pulses to the image sensor 107 according to an instruction from the controller 101. The four-phase pulse and the filed shift pulse are used in vertical transfer, and the two-phase pulse and the shutter pulse are used in horizontal transfer.

The image sensor 107 is composed of, for example, a solid-state imaging element such as CCD (Charge Coupled Device) or CMOS (Complementary Metal Oxide Semiconductor). The image sensor 107 is driven by an operating pulse from the timing generator 106 and photoelectrically converts a subject image guided from the imaging optical system 103. In this way, an image signal representing a captured image is outputted to the signal processing section 110. The image signal to be outputted is a signal synchronized with the operating pulse from the timing generator 106, and is a RAW signal (raw signal) of a Bayer array including the three primary colors of red (R), green (G), and blue (B).

The detector 108 detects the level of RAW signal (e.g., luminance information). The result obtained by the detector 108 is outputted to the controller 101 as detection information that indicates the brightness of an input image.

The gain adjustor 109 multiplies an input signal by gain to maintain a fixed signal level in the signal processing of the subsequent stage. The gain to be multiplied by the gain adjustor 109 is controlled in accordance with a gain control signal from the controller 101.

The image processing functions to be performed in the signal processing section 110 and the following components may be implemented, for example, by using a DSP (Digital Signal Processor). The signal processing section 110 performs an image signal processing, such as noise reduction, white balance adjustment, color correction, edge enhancement, gamma correction, and resolution conversion, on the image signal inputted from the image sensor 107. The signal processing section 110 may temporarily store a digital image signal in the memory 104. The RAW/YC conversion section 111 converts the RAW signal inputted from the signal processing section 110 into a YC signal, and outputs the YC signal to the motion vector estimating section 112. In this regard, the YC signal is an image signal including a luminance component (Y) and a red/blue chrominance component (Cr/Cb).

The motion vector estimating section 112 reads image signals of a target image and a reference image, for example, from the memory 104. The motion vector estimating section 112 estimates a motion vector (a local motion vector) between these images, for example, by a process such as block matching. Further, the motion vector estimating section 112 calculates a global motion by evaluating the reliability for the local motion vector. A global motion vector is calculated for each target block by using the calculated global motion.

The motion vector estimating section 112 determines whether a target block is a background or a moving subject based on the local motion vector and the global motion vector. The motion vector estimating section 112 decides one of the local motion vector and the global motion vector as a motion vector for the NR process depending on the result of determination. The motion vector estimating section 112 outputs a target image, a reference image corresponding to the target image, and a motion vector for the NR process to the motion-compensated image generation section 113.

The motion-compensated image generation section 113 compensates for motion between the target image and the reference image by using a motion vector for the NR process supplied from the motion vector estimating section 112 and then generates a motion-compensated image. More specifically, the motion-compensated image is generated by performing a process corresponding to global motion based on the motion vector for the NR process, that is, a transformation process including translation (parallel shifting), rotation, scaling, or the like, on the reference image. The motion-compensated image generation section 113 outputs the generated motion-compensated image and the target image to the image-to-be-added generation section 114.

The image-to-be-added generation section 114 acquires at least a motion-compensated image and a reference image. In this example, the image-to-be-added generation section 114 further acquires a target image. An image to be acquired (motion-compensated image, reference image, or the like) may be acquired in units of frames, in units of blocks, or in units of pixels. The image-to-be-added generation section 114 blends the motion-compensated image with the reference image by a predetermined blending ratio σ, and then generates an image-to-be-added. The blending ratio σ is supplied from, for example, the controller 101. In other words, the image-to-be-added generation section 114 functions as an example of the image acquisition unit and the image generator in the appended claims. The image-to-be-added generation section 114 outputs the target image and the image-to-be-added to the image adder 115.

The image adder 115 performs the frame NR process by adding the target image to the image-to-be-added and generates an output image. The generated output image becomes an image with reduced noise. The generated output image is stored, for example, in the memory 104. The generated output image may be displayed on the display 123.

The estimation section 116 estimates motion of the imaging device 100. The estimation section 116 may estimate motion of the imaging device 100, for example, by estimating the state of connection with a fixing member for fixing the imaging device 100. The motion of the imaging device 100 may be estimated by estimating a predetermined movement of the imaging device 100 using a sensor (acceleration sensor, gyro sensor, or the like) incorporated into the imaging device 100. The estimation section 116 outputs the signal obtained by estimation to the controller 101 as the estimated signal.

The still image codec 120, when receiving an instruction to shoot a still image from the operating section 102 (in a still image shooting mode), reads an image signal subjected to the NR process from the memory 104, compresses the image signal by a predetermined compression coding method such as JPEG (Joint Photographic Experts Group), and causes the storage 105 to store the compressed image data. In addition, the still image codec 120, when receiving an instruction to reproduce a still image from the operating section 102 (in a still image reproduction mode), reads the image data from the storage 105, decompresses the image data by a predetermined compression coding method such as JPEG, and provides the decompressed image signal to the NTSC encoder 122.

The moving image codec 121, when receiving an instruction to shoot a moving image from the operating section 102 (in a moving image shooting mode), reads an image signal subjected to the NR process from the memory 104, compresses the image signal by a predetermined compression coding method such as MPEG (Moving Picture Experts Group), and causes the storage 105 to store the compressed image data. In addition, the moving image codec 121, when receiving an instruction to reproduce a moving image from the operating section 102 (in a moving image reproduction mode), reads the image data from the storage 105, decompresses the image data by a predetermined compression coding method such as MPEG, and provides the decompressed image signal to the NTSC encoder 122.

The NTSC (National Television System Committee) encoder 122 converts the image signal into an NTSC system standard color video signal, and provides it to the display 123. At the time of shooting a still image or at the time of shooting a moving image, the NTSC encoder 122 reads the image signal subjected to the NR process from the memory 104 and provides the read image signal to the display 122 as a through-the-lens image or a captured image. Further, at the time of reproducing a still image or at the time of reproducing a moving image, the NTSC encoder 122 may acquire the image signal from the still image codec 120 or the moving image codec 121, and may provide the acquired image signal to the display 123 as a reproduced image.

The display 123 displays a video signal acquired from the NTSC encoder 122. The display 123 may be an LCD (Liquid Crystal Display) or an organic EL (Electro-Luminescence) display. Further, the video data outputted from the NTSC encoder 122 may be outputted to the outside from the imaging device 100, using a communication section such as HDMI (High-Definition Multimedia Interface) (registered trademark) which is not shown.

[Configuration of Gain Adjustor]

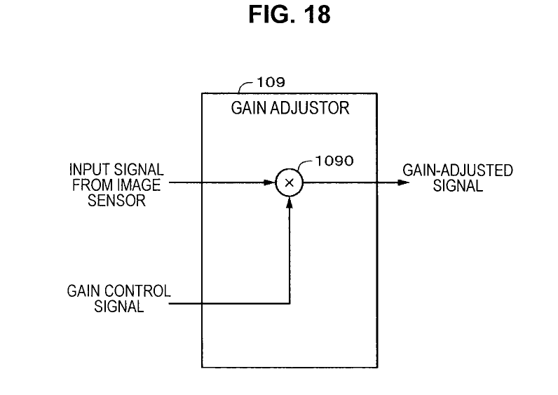

FIG. 18 illustrates an exemplary configuration of the gain adjustor 109. The gain adjustor 109 includes a multiplier 1090. The gain adjustor 109 receives the image signal from the image sensor 107 via the detector 108. Further, the gain adjustor 109 is supplied with a gain control signal from the controller 101. The gain control signal is a signal that indicates gain calculated by the controller 101 based on detection information obtained by the detector 108. The multiplier 1090 of the gain adjustor 109 multiplies the inputted image signal by the gain according to the gain control signal. The gain-adjusted image signal is outputted from the gain adjustor 109.

The controller 101 adjusts a gain, for example, such that the adjusted level is kept constant until the level of the image signal reaches a predetermined input level. However, if the level of the image signal becomes smaller than the predetermined input level, the controller 101 sets the gain such that the adjusted level gets dark without adjusting the gain.

[Configuration of Motion Vector Estimating Section]

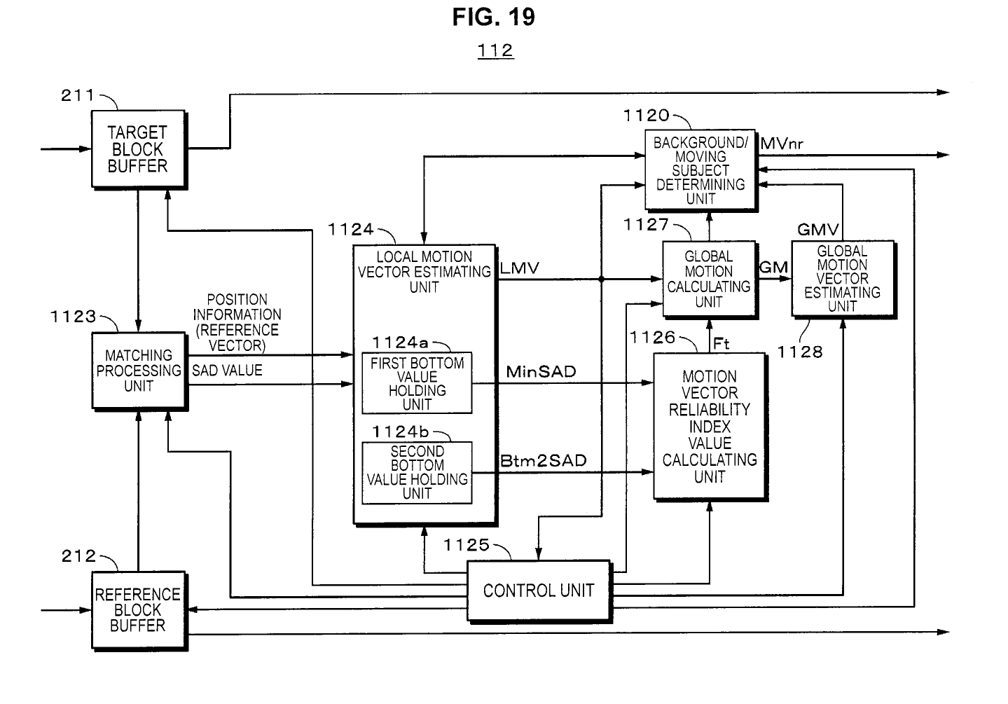

FIG. 19 illustrates an exemplary configuration of the motion vector estimating section 112. The motion vector estimating section 112 includes a target block buffer 211 that holds pixel data of a target block and a reference block buffer 212 that holds pixel data of a reference block.

Moreover, the motion vector estimating section 112 includes a matching processing unit 1123 for calculating an SAD value for pixels corresponding to the target block and the reference block. In addition, the motion vector estimating section 112 includes a local motion vector estimating unit 1124 that estimates a local motion vector from SAD value information outputted from the matching processing unit 1123. The motion vector estimating section 112 further includes a control unit 1125, a motion vector reliability index value calculating unit 1126, a global motion calculating unit 1127, a global motion vector estimating unit 1128, a background/moving subject determining unit 1120.

The control unit 1125 controls the sequence of processes in the motion vector estimating section 112, and thus supplies a control signal to each component as illustrated.

The target block buffer 211 acquires image data of the specified target block from among image data of a target frame under the control of the control unit 1125. The target block buffer 211 acquires image data of a target block from the memory 104 or the RAW/YC conversion section 111. The acquired image data of target block is outputted to the matching processing unit 1123. Further, the target block buffer 211 outputs the acquired image data of target block to the motion-compensated image generation section 113.

The reference block buffer 212 acquires image data in the specified matching processing range from among image data of a reference frame of the memory 104 under the control of the control unit 1125. The reference block buffer 212 sequentially supplies image data of a reference block from among image data in the matching processing range to the matching processing unit 1123. Further, the reference block buffer 212 outputs pixel data of the reference block specified as the motion-compensated block to the motion-compensated image generation section 113 under the control of the control unit 1125.

The matching processing unit 1123 receives image data of a target block from the target block buffer 211 and receives image data of a reference block from the reference block buffer 212. The target block may be a target block on a base plane or a reduced plane. The same is true for the reference block. The matching processing unit 1123 performs the block matching process in accordance with the control of the control unit 1125. The matching processing unit 1123 supplies the reference vector (position information of the reference block) and an SAD value obtained by performing the block matching process to the local motion vector estimating unit 1124.

The local motion vector estimating unit 1124 a first bottom value holding unit 1124a that holds a first bottom value of SAD values and a second bottom value holding unit 1124b that holds a second bottom value of SAD values. The local motion vector estimating unit 1124 estimates the first bottom value of the SAD values and the second bottom value of the SAD values among SAD values from the matching processing unit 1123.

The local motion vector estimating unit 1124 updates the first bottom value of the SAD value of the first bottom value holding unit 1124a for the SAD value and position information thereof (reference vector). In addition, the local motion vector estimating unit 1124 updates the second bottom value of the SAD value of the second bottom value holding unit 1124b for the SAD value and position information thereof (reference vector). The local motion vector estimating unit 1124 performs the updating process until the block matching process is completed for all of the reference blocks of the matching process range.

When the block matching process is completed, the first bottom value of the SAD values for the target block at that time and position information thereof (reference vector) are stored and held in the first bottom value holding unit 1124a for the SAD value. In addition, the second bottom value of the SAD values and position information thereof (reference vector) are stored and held in the second bottom value holding unit 1124b for the SAD value.

When the block matching process is completed for all of the reference blocks of the matching process range, the local motion vector estimating unit 1124 estimates information (position information) of the reference vector held in the first bottom value holding unit 1124a for the SAD value as a local motion vector. In addition, SAD values of a plurality of reference blocks near a reference block having the minimum SAD value are held, and thus a local motion vector having sub-pixels with high accuracy may be estimated by a quadratic curve approximation interpolation process.

The local motion vector (LMV) obtained by the local motion vector estimating unit 1124 is supplied to the global motion calculating unit 1127. The global motion calculating unit 1127 temporarily holds the received local motion vector.

When the calculation process of a local motion vector by the local motion vector estimating unit 1124 is completed, the control unit 1125 causes the motion vector reliability index value calculating unit 1126 to be enabled so that the motion vector reliability index value calculating unit 1126 starts the operation. The local motion vector estimating unit 1124 then supplies a minimum value of SAD values, MinSAD, of the first bottom value holding unit 1124a and a second bottom value of SAD values, Btm2SAD, of the second bottom value holding unit 1124b to the motion vector reliability index value calculating unit 1126.

The motion vector reliability index value calculating unit 1126 calculates an index value Ft indicating the reliability of motion vector in accordance with Equation (1) described above by using the information being supplied. The motion vector reliability index value calculating unit 1126 then supplies the calculated index value Ft to the global motion calculating unit 1127. The global motion calculating unit 1127 temporarily holds the inputted index value Ft in association with the local motion vector supplied at that time.

When the process is completed for all of the target blocks of a target frame, the control unit 1125 instructs the global motion calculating unit 1127 to start the process of calculating the global motion.

The global motion calculating unit 1127, when receiving the instruction from the control unit 1125, initially, performs determination of the reliability for the plurality of local motion vectors being held by using the corresponding index value Ft being held. Then, only a local motion vector having high reliability is extracted.

The global motion calculating unit 1127 extracts a local motion vector by regarding a local motion vector having an index value Ft which is greater than a threshold as the local motion vector having high reliability.

The global motion calculating unit 1127 calculates global motion (GM) by using only the extracted local motion vector having high reliability. In the example, the global motion calculating unit 1127 estimates and calculates global motion using affine transformations. The global motion calculating unit 1127 supplies the calculated global motion to the global motion vector estimating unit 1128.

The global motion vector estimating unit 1128 applies global motion to a coordinate position (for example, a center position) of a target block and thus calculates a global motion vector of the target block. A method of calculating a global motion vector is not limited to a method of calculating a global motion vector from a local motion vector in a screen. For example, a global motion vector may be inputted as external information obtained from a gyroscope or the like.

The global motion vector estimating unit 1128 supplies the calculated global motion vector (GMV) to the background/moving subject determining unit 1120. The background/moving subject determining unit 1120 is also supplied with the local motion vector from the local motion vector estimating unit 1124.

The background/moving subject determining unit 1120 compares a local motion vector for each target block with a global motion vector, and determines the degree of matching between them for a target block, that is, the degree of background matching. In this case, the background/moving subject determining unit 1120 compares a correlation value (for example, SAD value) for a reference block corresponding to the local motion vector with a correlation value (for example, SAD value) for a reference block corresponding to the global motion vector, and performs determination between a background and a moving subject.

The local motion vector and the SAD value obtained to calculate the global motion in the local motion vector estimating unit 1124 can be used for the comparison in the background/moving subject determining unit 1120.

However, in this case, the local motion vector estimating unit 1124 is necessary to hold the local motion vector or the SAD value during the time necessary to perform the process in the global motion calculating unit 1127 or the global motion vector estimating unit 1128. In this case, in particular, for the SAD value being held, it is not determined that the global motion vector corresponds to which one of reference vectors, thus it is necessary to hold all of the SAD values of an SAD table for each respective target block. Thus, a memory for holding the local motion vector or the SAD value is necessary to have a large storage capacity.

In view of this fact, the local motion vector estimating unit 1124 may recalculate a local motion vector or an SAD value for the comparison in the background/moving subject determining unit 1120. Accordingly, it is not necessary to provide a memory for holding local motion vectors or SAD values to the local motion vector estimating unit 1124, thereby avoiding the memory capacity issue.

The background/moving subject determining unit 1120 determines a hit rate β indicating the degree of background matching for a target block by using the recalculated local motion vector and SAD value. The background/moving subject determining unit 1120 also acquires an SAD value for a reference vector (position of reference block) that is matched with the global motion vector at the time of the recalculation. The background/moving subject determining unit 1120 then determines whether the target block is a background portion or a moving subject portion by using the recalculated local motion vector or SAD value.

The background/moving subject determining unit 1120 corrects an SAD value for a reference block corresponding to a global motion vector to a value which reflects image noise as described above. The SAD value for a reference block corresponding to the global motion vector is necessary to be compared with the SAD value for a reference block corresponding to the local motion vector.

The background/moving subject determining unit 1120 then compares the corrected SAD value with the SAD value for a reference block corresponding to the local motion vector. The background/moving subject determining unit 1120 then determines whether the corrected SAD value for a reference block corresponding to the global motion vector is smaller than the SAD value for a reference block corresponding to the local motion vector. If it is determined that the corrected SAD value for a reference block corresponding to the global motion vector is smaller than the SAD value for a reference block corresponding to the local motion vector, then the background/moving subject determining unit 1120 determines that the target block is a background portion.

When the degree of background matching indicates the hit rate β such that the target block is regarded as a background portion, the background/moving subject determining unit 1120 outputs the global motion vector as a motion vector for the NR process (MVnr). In cases except that of the above, the background/moving subject determining unit 1120 outputs the local motion vector as a motion vector for the NR process.

The motion vector for the NR process which is outputted from the background/moving subject determining unit 1120 is supplied to the motion-compensated image generation section 113.

[Details of Target Block Buffer]

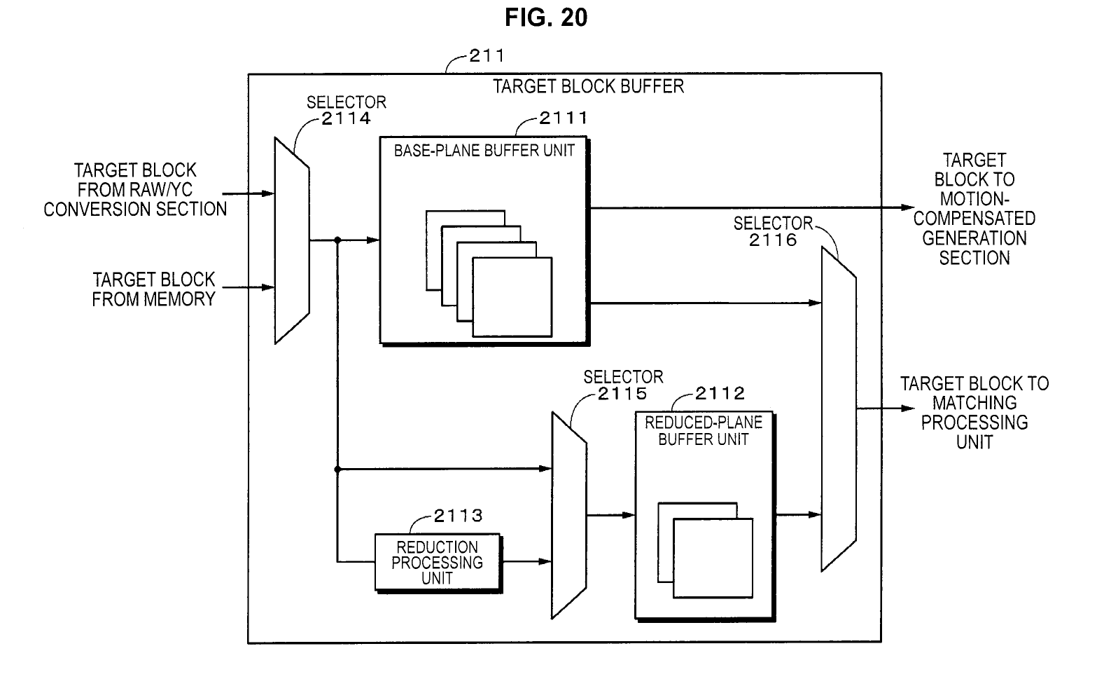

FIG. 20 illustrates an example of the details of the target block buffer 211. The target block buffer 211 acquires pixel data of a base-plane target frame and pixel data of a reduced-plane target frame provided from the memory 104 or the RAW/YC conversion section 111. The acquisition source of the pixel data can be switched by a selector 2114. As an example, the target block buffer 211 acquires the pixel data from the memory 104 at the time of shooting a still image, but the target block buffer 211 acquires the pixel data from the RAW/YC conversion section 111 at the time of shooting a moving image. The pixel data of the reduced-plane target frame to be acquired is generated by the RAW/YC conversion section 111 or a reduced-plane generating unit 1154 included in the image adder 115, which will be described later, and is stored in the memory 104.

The target block buffer 211 accumulates the pixel data of the base-plane target frame in the base-plane buffer unit 2111. In addition, the target block buffer 211 accumulates the pixel data of the reduced-plane target frame in the reduced-plane buffer unit 2112. For example, at the time of shooting a moving image, when the pixel data of the reduced-plane target frame is not included in the pixel data acquired from the RAW/YC conversion section 111, the target block buffer 211 generates the pixel data of the reduced-plane target frame from the pixel data of the base-plane target frame by using a reduction processing unit 2113. Whether the reduction processing unit 2113 is used or not can be switched by a selector 2115.

[Details of Reference Block Buffer]

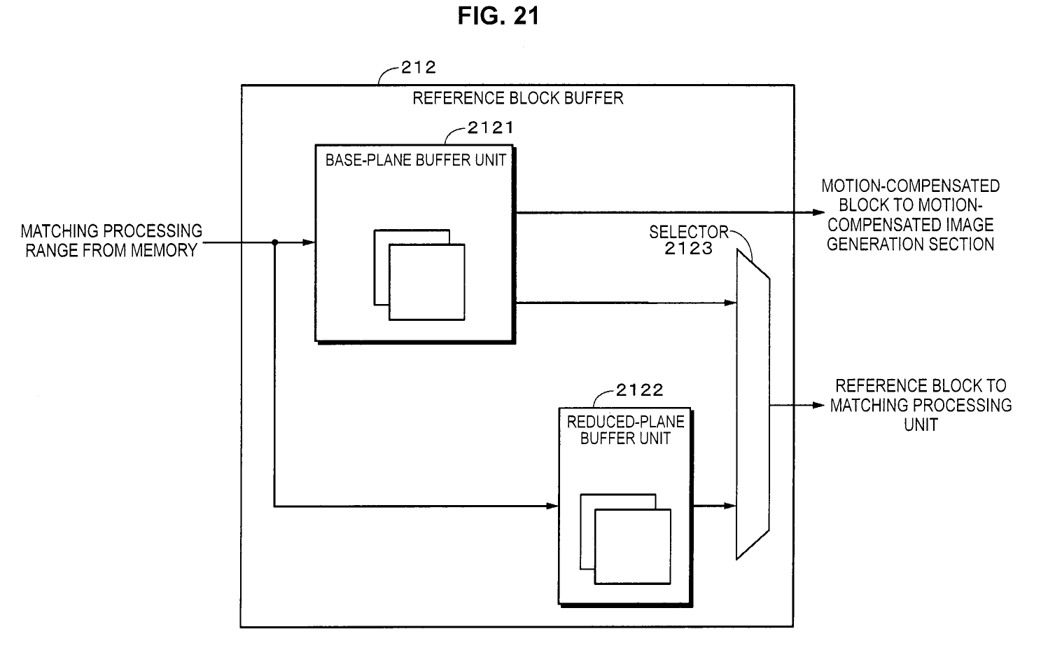

FIG. 21 illustrates an example of the detailed configuration of the reference block buffer 212 in the motion vector estimating section 112. The reference block buffer 212 includes a base-plane buffer unit 2121, a reduced-plane buffer unit 2122, and a selector 2123.

The reference block buffer 212 acquires pixel data of the reduced-plane matching processing range and pixel data of the base-plane matching processing range from the memory 104. The acquired pixel data of the reduced-plane matching processing range and the acquired pixel data of the base-plane matching processing range are accumulated in the reduced-plane buffer unit 2122 and the base-plane buffer unit 2121, respectively.

Furthermore, the reference block buffer 212 provides the pixel data of the base-plane reference block or the reduced-plane reference block to the motion-compensated image generation section 113 and the matching processing unit 1123. The motion-compensated image generation section 113 is provided with pixel data in the range specified as the motion-compensated block from among pixel data in the base-plane matching processing range accumulated in the base-plane buffer unit 2121. The matching processing unit 1123 is provided with pixel data of the reduced reference block to be used for the block matching process from among pixel data in the reduced-plane matching processing range accumulated in the reduced-plane buffer unit 2122 at the time of performing the block matching process in the reduced plane.

Moreover, at the time of performing the block matching process in the base plane, the pixel data of the base-plane reference block to be used for the block matching process from among pixel data in the base-plane matching processing range accumulated in the base-plane buffer unit 2121 is provided. The pixel data to be provided to the matching processing unit 1123 is switched by the selector 2123.

As described above, the motion vector estimating section 112 outputs a target block, a motion-compensated block, and a motion block for the NR process, and these blocks are supplied to the motion-compensated image generation section 113. The motion-compensated image generation section 113 performs a transformation process corresponding to the motion vector for the NR process on the motion-compensated block. A block compensated for its motion by the motion vector for the NR process, which is obtained by performing the transformation process, is appropriately referred to as a motion-compensated image block. The generated motion-compensated image block is supplied to the image-to-be-added generation section 114. In addition, the motion-compensated image generation section 113 outputs the target block supplied from the motion vector estimating section 112 to the image-to-be-added generation section 114.

[Details of Image-to-be-Added Generation Section]

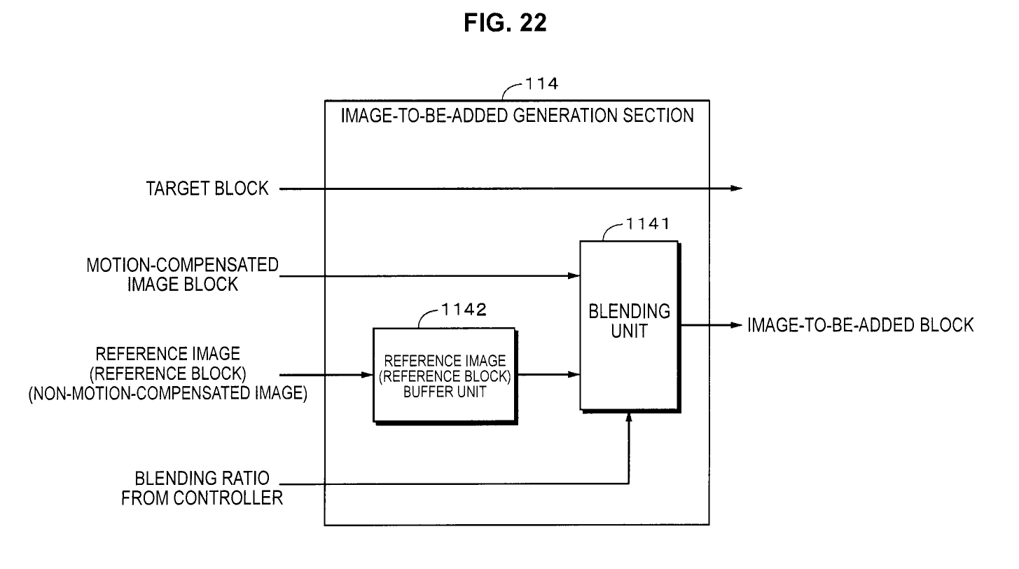

FIG. 22 illustrates an example of the detailed configuration of the image-to-be-added generation section 114. The image-to-be-added generation section 114 includes a blending unit 1141 and a reference block buffer unit 1142. As described above, the pixel data of the base-plane target block and the pixel data of the motion-compensated image block are inputted from the motion-compensated image generation section 113 to the image-to-be-added generation section 114. The pixel data of the base-plane target block is outputted to the image adder 115 through the image-to-be-added generation section 114. The pixel data of the motion-compensated image block is inputted to the blending unit 1141.

The image-to-be-added generation section 114 is supplied with a reference block from the memory 104. The reference block is a block corresponding to the motion-compensated image block, but it is a block that is not compensated for its motion. The reference block may be held, for example, in the reference block buffer unit 1142 to adjust the position relative to the motion-compensated image block. The reference block is then read from the reference block buffer unit 1142 at an appropriate timing and is supplied to the blending unit 1141.

The image-to-be-added generation section 114 is further supplied with the blending ratio σ from the controller 101 via the system bus 130. As described above, the blending ratio σ is the proportion of the reference image to the motion-compensated image. The blending ratio σ is set by the controller 101 based on the detection information obtained by the detector 108. An example of setting of the blending ratio σ has been described above with reference to FIG. 18, etc., and thus the description thereof is appropriately omitted for avoiding repetition.

The blending unit 1141 blends the motion-compensated image block with the reference block in accordance with the blending ratio σ being inputted and then generates a block of an image-to-be-added (is appropriately referred to as an image-to-be-added block). The generated image-to-be-added block is outputted to the image adder 115. The adjusted level of an input image adjusted by the gain adjustor 109 may be inputted to the blending unit 1141. The blending unit 1141 may be configured to acquire the blending ratio σ corresponding to the adjusted level. For example, the blending unit 1141 stores a table in which the adjusted level and the blending ratio σ corresponding to the adjusted level are described, and may determine the blending ratio σ corresponding to the adjusted level based on the table.

[Details of Image Adder]

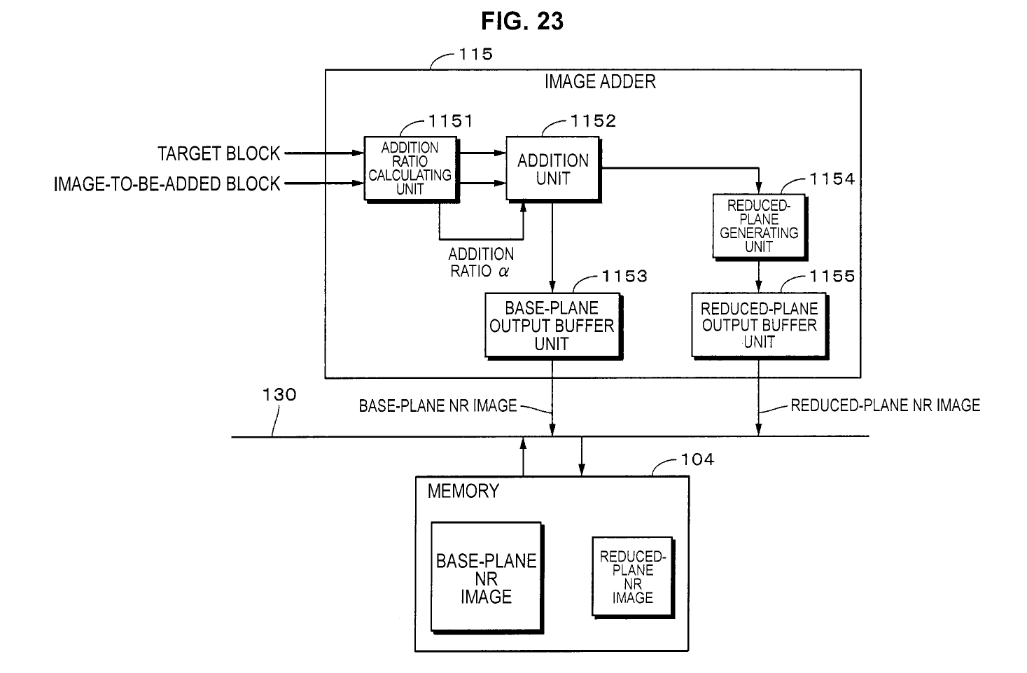

FIG. 23 illustrates an example of the detailed configuration of the image adder 115. The image adder 115 includes an addition ratio calculating unit 1151, an addition unit 1152, a base-plane output buffer unit 1153, a reduced-plane generating unit 1154, and a reduced-plane output buffer unit 1155.

The addition ratio calculating unit 1151 acquires pixel data of the base-plane target block and pixel data of the image-to-be-added block from the image-to-be-added generation section 114, and calculates an addition ratio of theses blocks. The base-plane target block and the image-to-be-added block may be added, for example, by using an addition method such as simple addition method or average addition method. The addition ratio calculating unit 1151 appropriately calculates an addition ratio σ according to such a method. The addition ratio calculating unit 1151 provides the calculated addition ratio, the pixel data of the base-plane target block, and the pixel data of the image-to-be-added block to the addition unit 1152.

The addition unit 1152 acquires the pixel data of the base-plane target block, the pixel data of the image-to-be-added block, and the addition ratio of these blocks from the addition ratio calculating unit 1151. The addition unit 1152 adds the pixel data of the base-plane target block and the pixel data of the image-to-be-added block at the acquired addition ratio, and generates a base-plane NR block with noise reduced by the effect of the frame NR. The addition unit 1152 provides pixel data of the base-plane NR block to the base-plane output buffer unit 1153 and the reduced-plane generating unit 1154.

The base-plane output buffer unit 1153 accumulates pixel data of the base-plane NR block provided from the addition unit 1152, and finally, provides a base-plane NR image to the memory 104 as an output image. The base-plane NR image is stored in the memory 104.

The reduced-plane generating unit 1154 reduces pixel data of the base-plane NR block provided from the addition unit 1152, and generates pixel data of the reduced-plane NR block. The reduced-plane generating unit 1154 provides the pixel data of the reduced-plane NR block to the reduced-plane output buffer unit 1155.

The reduced-plane output buffer unit 1155 accumulates pixel data of the reduced-plane NR block provided from the reduced-plane generating unit 1154, and the pixel data is stored in the memory 104 as a reduced-plane NR image. For example, when a reference image is further superimposed on a target image subjected to the frame NR at the time of shooting a still image, the reduced-plane NR image stored in the memory 104 may be used as a reduced-plane target image. In addition, when the frame NR is performed on the subsequent frame as a target image at the time of shooting a moving image, the reduced-plane NR image stored in the memory 104 may be used as a reduced-plane reference image.

As described above, according to an embodiment of the present disclosure, it is possible to generate at least an appropriate image to be added. In addition, for example, it is possible to perform the frame NR process using an appropriate image to be added even when shooting an image in a dark place.

### 2. Modifications

Although embodiments of the present disclosure have been described in detail in the above, the present disclosure is not limited to the embodiments described above, and various modifications can be made based on the technical scope of the present disclosure. Modifications will be described below.

Processing units are illustrated in each process of an embodiment, and processing units can be appropriately modified. Processing units can be appropriately set in units of images, blocks, a plurality of blocks, and pixels. In addition, the size of block can be appropriately modified.

The image processing device or imaging device may be provided with a sensor or the like, and illuminance may be acquired using the sensor or the like. The blending ratio may be set in accordance with the acquired luminance.

As a parameter indicating the height of correlation for each block or other units, a value other than the SAD value may be used. For example, SSD (Sum of Squared Difference) that is the sum of the squared differences between luminance values may be used.

Note that the configurations and processing in the embodiments and modifications can be combined as appropriate, as long as a technical inconsistency does not occur. The order of the respective processes in the illustrated processing flow can be changed as appropriate, as long as a technical inconsistency does not occur.

Furthermore, an embodiment of the present disclosure can be implemented as a method or a program, in addition to a device. The program that implements the functions of the embodiments described above is provided, directly or by using wire/wireless communications, from a recording medium to a system or a device including a computer capable of executing the program. The functions of the embodiments are achieved by causing the computer of the system or the device to execute the provided program.

In this case, the program may take any form, e.g., an object code, a program executed by an interpreter, and script data supplied to an OS, as long as it has the function of the program.

As a recording medium used to supply the program, a flexible disk, a hard disk, a magnetic recording medium such as magnetic tape, an optical/magneto-optical storage medium such as MO (Magneto-Optical disk), CD-ROM, CD-R (Recordable), CD-RW (Rewritable), DVD-ROM, DVD-R, or DVD-RW, a nonvolatile semiconductor memory, or the like can be used.

An example of the method of supplying the program via wire/wireless communications includes a method of storing a data file (program data file) in a server on a computer network, and downloading the program data file to a connected client computer. The data file (program data file) may be a computer program itself which implements an embodiment of the present disclosure or may be a computer program for implementing an embodiment of the present disclosure on a client computer, e.g., a compressed file including an automatic installation function. In this case, the program data file may be divided into a plurality of segment files, and the segment files may be distributed among different servers.

The present disclosure can be applied to a so-called cloud system in which the processing described above is distributed and performed by a plurality of devices. In a system in which the plurality of processes illustrated in an embodiment or the like are performed by a plurality of devices, it is possible to implement the present disclosure as a device for executing at least some of the processes.

Additionally, the present technology may also be configured as below.

(1)
An image processing device including:

an image acquisition unit configured to acquire a first image obtained using a motion vector indicating motion between frames and a second image used as a reference image to obtain the motion vector; and

an image generator configured to generate a third image by blending the first image with the second image by a predetermined blending ratio.

(2)
The image processing device according to (1), further including:

a detector configured to detect a brightness of an input image; and

a blending ratio setting unit configured to set the blending ratio based on the brightness of the input image.

(3)
The image processing device according to (2), wherein the blending ratio setting unit sets a blending ratio of the second image to the first image to zero when the brightness of the input image is greater than a threshold.
(4)
The image processing device according to (2), wherein the blending ratio setting unit sets the blending ratio such that a blending ratio of the second image to the first image decreases as the brightness of the input image increases.
(5)
The image processing device according to any one of (1) to (4), further including:

an image adder configured to add the third image and a target image.

(6)
The image processing device according to (2), further including:

a gain setting unit configured to set gain for the input image based on the brightness of the input image,

wherein the blending ratio setting unit sets the blending ratio in accordance with a level of the input image adjusted by the set gain.

(7)
The image processing device according to any one of (1) to (6), wherein the first image is obtained by using at least one of a first motion vector and a second motion vector different from the first motion vector.
(8)
The image processing device according to (7),

wherein the first motion vector is a local motion vector obtained for each block in which an image is divided into a plurality of regions, and

wherein the second motion vector is a global motion vector obtained based on one or more of the local motion vectors.

(9)
An image processing method in an image processing device, the image processing method including:

acquiring a first image obtained using a motion vector indicating motion between frames and a second image used as a reference image to obtain the motion vector; and

generating a third image by blending the first image with the second image by a predetermined blending ratio.

(10)
A program for causing a computer to execute an image processing method in an image processing device, the image processing method including:

acquiring a first image obtained using a motion vector indicating motion between frames and a second image used as a reference image to obtain the motion vector; and

generating a third image by blending the first image with the second image by a predetermined blending ratio.

(11)
An imaging device including:

an imaging unit;

an image acquisition unit configured to acquire a first image obtained using a motion vector indicating motion between frames and a second image used as a reference image to obtain the motion vector, the second image being obtained through the imaging unit;

an image generator configured to generate a third image by blending the first image with the second image by a predetermined blending ratio; and

an image adder configured to add the third image and a target image.

What is claimed is:

1. An image processing device comprising:
an image acquisition unit configured to acquire a first image obtained using a motion vector indicating motion between frames and a second image used as a reference image to obtain the motion vector; and
an image generator configured to generate a third image by blending the first image with the second image by a predetermined blending ratio.

2. The image processing device according to claim 1, further comprising:
a detector configured to detect a brightness of an input image; and
a blending ratio setting unit configured to set the blending ratio based on the brightness of the input image.

3. The image processing device according to claim 2, wherein the blending ratio setting unit sets a blending ratio of the second image to the first image to zero when the brightness of the input image is greater than a threshold.

4. The image processing device according to claim 2, wherein the blending ratio setting unit sets the blending ratio such that a blending ratio of the second image to the first image decreases as the brightness of the input image increases.

5. The image processing device according to claim 1, further comprising:
an image adder configured to add the third image and a target image.

6. The image processing device according to claim 2, further comprising:
a gain setting unit configured to set gain for the input image based on the brightness of the input image,
wherein the blending ratio setting unit sets the blending ratio in accordance with a level of the input image adjusted by the set gain.

7. The image processing device according to claim 1, wherein the first image is obtained by using at least one of a first motion vector and a second motion vector different from the first motion vector.

8. The image processing device according to claim 7,
wherein the first motion vector is a local motion vector obtained for each block in which an image is divided into a plurality of regions, and
wherein the second motion vector is a global motion vector obtained based on one or more of the local motion vectors.

9. An image processing method in an image processing device, the image processing method comprising:
acquiring a first image obtained using a motion vector indicating motion between frames and a second image used as a reference image to obtain the motion vector; and
generating a third image by blending the first image with the second image by a predetermined blending ratio.

10. A program for causing a computer to execute an image processing method in an image processing device, the image processing method comprising:
acquiring a first image obtained using a motion vector indicating motion between frames and a second image used as a reference image to obtain the motion vector; and
generating a third image by blending the first image with the second image by a predetermined blending ratio.

11. An imaging device comprising:
an imaging unit;
an image acquisition unit configured to acquire a first image obtained using a motion vector indicating motion between frames and a second image used as a reference image to obtain the motion vector, the second image being obtained through the imaging unit;
an image generator configured to generate a third image by blending the first image with the second image by a predetermined blending ratio; and
an image adder configured to add the third image and a target image.
